(19) United States
(12) Patent Application Publication
(10) Pub. No.: US 2025/0308788 A1
(43) Pub. Date: Oct. 2, 2025

(54) MULTILAYER CERAMIC CAPACITOR AND METHOD OF PRODUCING MULTILAYER CERAMIC CAPACITOR

(71) Applicant: TAIYO YUDEN CO., LTD., Tokyo (JP)

(72) Inventor: Ayumi MATSUOKA, Tokyo (JP)

(21) Appl. No.: 19/077,522

(22) Filed: Mar. 12, 2025

(30) Foreign Application Priority Data
Mar. 29, 2024 (JP) 2024-055351

(51) Int. Cl. H01G 4/224; H01G 4/008; H01G 4/12; H01G 4/232; H01G 4/248; H01G 4/30

(52) U.S. Cl. CPC H01G 4/224; H01G 4/008; H01G 4/232; H01G 4/248; H01G 4/30; H01G 4/1227

(57) ABSTRACT

A multilayer ceramic capacitor includes a capacitance portion, in which dielectric layers and internal electrode layers are alternately stacked, and a cover layer arranged on an outer side of the capacitance portion in a stacking direction of the capacitance portion. The cover layer includes a perovskite compound represented by a general formula ABO₃, and one or more elements selected from the group consisting of Cu, Au, Ag, Al, Ir, and W, where a number of atoms of the one or more elements is 0.002 or greater and 0.15 or less relative to 100 atoms of a B-site element of the general formula.

### CROSS-REFERENCE TO RELATED APPLICATIONS

This patent application is based on and claims priority to Japanese Patent Application No. 2024-055351 filed on Mar. 29, 2024, the entire contents of which are incorporated herein by reference.

### BACKGROUND OF THE INVENTION

### Field of the Invention

The present disclosure relates to multilayer ceramic capacitors and methods of producing multilayer ceramic capacitors.

### Description of the Related Art

A multilayer ceramic capacitor (MLCC) includes a capacitance portion, in which dielectric layers and internal electrode layers are alternately stacked, and cover layers respectively arranged on outer sides of the capacitance portion in a stacking direction of the capacitance portion. Densification of the cover layers tends to be delayed because an amount of metal diffused from the internal electrodes is small during firing. When densification of the cover layers, which constitute surfaces, is not sufficient, moisture resistance of a resultant multilayer ceramic capacitor is likely to be reduced, which may lower reliability.

As a countermeasure for the above, it has been known that an amount of a sintering agent added to cover layers is set to be greater than an amount of a sintering agent added to a capacitance portion, and a sintering temperature of the cover layers and a sintering temperature of the dielectric layers are adjusted to be as equal as possible, thereby improving moisture resistance (see, for example, Japanese Laid-open Patent Application Publication No. 2018-170526).

### SUMMARY OF THE INVENTION

According to one aspect of the present disclosure, a multilayer ceramic capacitor includes a capacitance portion, in which dielectric layers and internal electrode layers are alternately stacked, and a cover layer arranged on an outer side of the capacitance portion in a stacking direction of the capacitance portion. The cover layer includes a perovskite compound represented by a general formula ABO₃, and one or more elements selected from the group consisting of Cu, Au, Ag, Al, Ir, and W, where a number of atoms of the one or more elements is 0.002 or greater and 0.15 or less relative to 100 atoms of a B-site element of the general formula.

### BRIEF DESCRIPTION OF THE DRAWINGS

FIG. 1 is a perspective view illustrating a multilayer ceramic capacitor according to one embodiment of the present disclosure;

FIG. 2 is a cross-sectional view taken along a line A-A in FIG. 1;

FIG. 3 is a cross-sectional view taken along a line B-B in FIG. 1;

FIG. 4 is an enlarged view of a section C in FIG. 2;

FIG. 5 is a flowchart illustrating a first embodiment of a method of producing a multilayer ceramic capacitor; and

FIG. 6 is a flowchart illustrating a second embodiment and a third embodiment of the method of producing the multilayer ceramic capacitor.

### DETAILED DESCRIPTION OF THE DISCLOSURE

When a large amount of a sintering agent is added to cover layers, electrostatic characteristics of dielectric layers may be impaired due to the diffusion of the sintering agent into a capacitance portion. Therefore, as a method of facilitating densification of the cover layers without relying on the sintering agent, firing at a high firing temperature is considered. When the firing temperature is set high, there is however a case where sufficient reliability cannot be achieved due to over-sintering of dielectric layers located in an inner area, or the like. Moreover, firing at a temperature as low as possible is desired in view of a reduction in energy consumption.

An object of the present disclosure is to provide a multilayer ceramic capacitor that can be produced at relatively low firing temperatures and has excellent moisture resistance.

Embodiments of the present disclosure will be described in detail hereinafter, but the present disclosure is not limited to these embodiments. In the present specification and drawings, constituent elements having substantially the same functional configurations are denoted by the same reference symbols, and redundant description may be omitted. In addition, an X-axis, a Y-axis, and a Z-axis orthogonal to each other are appropriately depicted in the drawings. The X-axis, the Y-axis, and the Z-axis define a fixed coordinate system that is fixed with respect to a multilayer ceramic capacitor. In the case where an outer shape of the multilayer ceramic capacitor is substantially a cuboid, the X-axis, the Y-axis, and the Z-axis may correspond to a length, a width, and a height of the multilayer ceramic capacitor, respectively.

### [Multilayer Ceramic Capacitor]

### (Configuration of Multilayer Ceramic Capacitor)

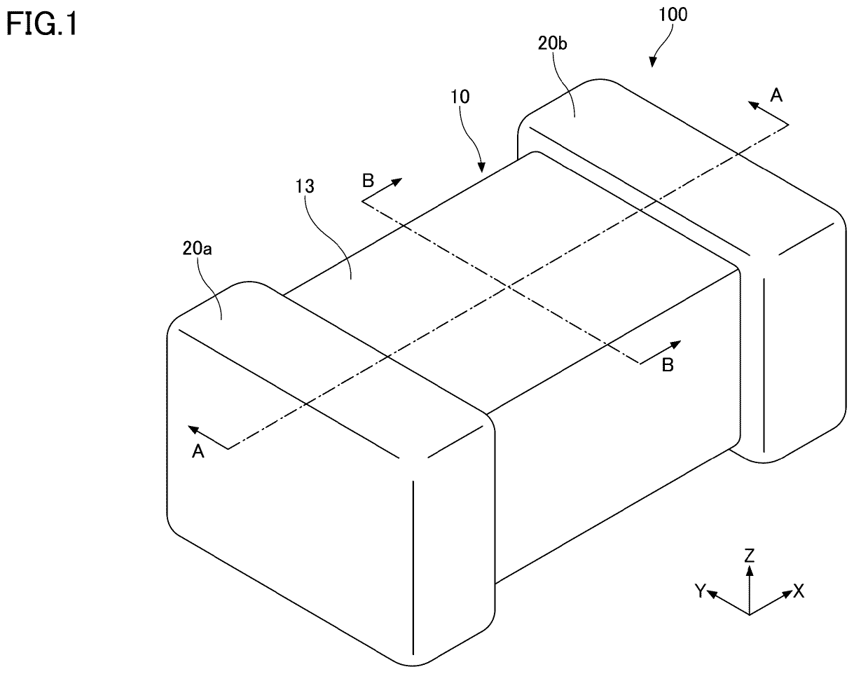

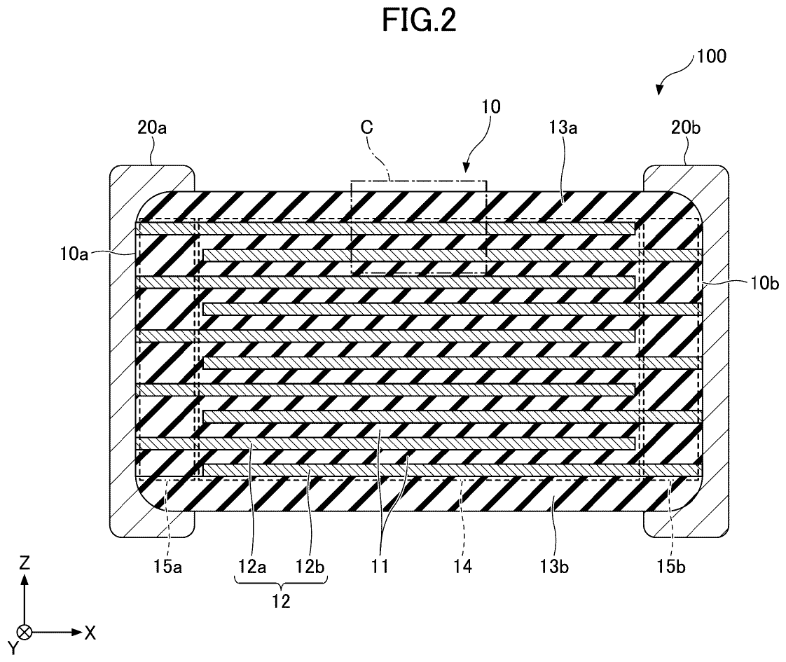

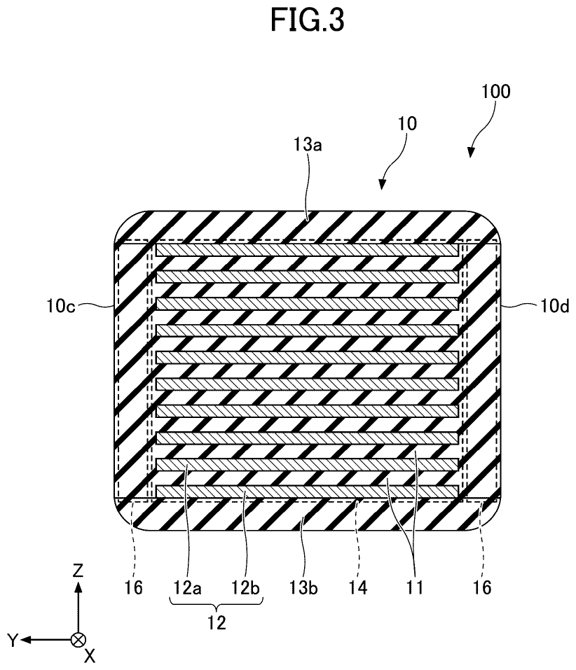

FIG. 1 is a perspective view illustrating a multilayer ceramic capacitor 100 according one embodiment of the present disclosure. FIG. 2 is a cross-sectional view taken along a line A-A in FIG. 1. FIG. 3 is a cross-sectional view taken along a line B-B in FIG. 1. As illustrated in FIGS. 1 to 3, the multilayer ceramic capacitor 100 includes a base body 10 having a substantially cuboid shape. Among the surfaces of the base body 10, two surfaces facing each other are referred to as a top surface and a bottom surface, respectively, and four surfaces connected to the top surface and the bottom surface are each referred to as a side surface. In general, the surface of the base body 10 facing a circuit board when the multilayer ceramic capacitor is mounted on the circuit board is referred to as a bottom surface, but the orientation of the surfaces is not limited to the above.

In the example illustrated in FIGS. 1 to 3, a first external electrode 20a and a second external electrode 20b are respectively disposed on the first side surface 10a and the second side surface 10b (see FIG. 2) that are two side surfaces of the base body 10 facing each other. The first external electrode 20a extends from the first side surface 10a to four surfaces adjacent to the first side surface 10a. The second external electrode 20b extends from the second side surface 10b to four surfaces adjacent to the second side surface 10b. Moreover, the first external electrode 20a and the second external electrode 20b are set apart from each other. The external electrodes may be disposed on any surfaces of the base body 10, and the locations of the external electrodes are not limited to the above two side surfaces.

The base body 10 includes a capacitance portion 14 in which dielectric layers 11 functioning as dielectrics and internal electrode layers 12 are alternately stacked. Each of the dielectric layers 11 includes a ceramic material. The internal electrode layers 12 include first internal electrode layers 12a and second internal electrode layers 12b. The first internal electrode layers 12a and the second internal electrode layers 12b are alternately stacked. An end of each first internal electrode layer 12a is led to the surface of the base body 10 on which the first external electrode 20a is disposed, i.e., the first side surface 10a in the example of FIGS. 1 to 3. An end of each second internal electrode layer 12b is led to the surface of the base body 10 on which the second external electrode 20b is disposed, i.e., the second side surface 10b in the example of FIGS. 1 to 3. According to the above configuration, the first internal electrode layers 12a and the second internal electrode layers 12b are alternately electrically connected to the first external electrode 20a and the second external electrode 20b. Thus, the multilayer ceramic capacitor 100 has a configuration in which capacitor units are stacked.

The stacking direction in which the dielectric layers 11 and the internal electrode layers 12 are stacked is a direction along a first axis. In FIGS. 1 to 3, the first axis, which indicates the stacking direction in which the dielectric layers 11 and the internal electrode layers 12 are stacked, is the Z-axis, and the first axial direction (the Z axial direction) is a direction in which the internal electrode layers face. An axis vertical to the first axis that indicates the stacking direction is a second axis. In FIGS. 1 to 3, the second axis, which is the axis vertical to the first axis indicating the stacking direction, is the X-axis, and the second axial direction (the X axial direction) is a direction in which the internal electrode layers 12 are led, a direction in which the first side surface 10a and the second side surface 10b of the base body 10 face, or a direction in which the first external electrode 20a and the second external electrode 20b face each other. The electrode leading direction (X-axial direction) is a direction along a longitudinal direction of the base body 10 in the example illustrated in FIGS. 1 to 3. The axis vertical to the first axis that indicates the stacking direction and vertical to the second axis is a third axis. In FIGS. 1 to 3, the third axis, which is an axis vertical to the first axis that is the stacking direction and vertical to the second axis, is the Y-axis, and is an axis extending a direction in which the third side surface 10c and the fourth side surface 10d (see FIG. 3) face among the four side surfaces of the base body 10. In the example illustrated in FIGS. 1 to 3, the third axial direction (the Y axial direction) is a direction along a width of the base body 10. The X axial direction, the Y axial direction, and the Z axial direction are vertical to one another. The stacking direction is not limited to the Z axial direction, and may be any direction. Therefore, the first axial direction that is the stacking direction may be the X axial direction, or the Y axial direction.

In the present specification, for the purpose of description of a general embodiment, a drawing exemplifying a specific embodiment may be used. However, features described with the coordinate axis system used in one embodiment can be applied to the general embodiment by reading a general coordinate system in which a stacking direction is set as a first axial direction in the general embodiment. For example, the features described as a specific embodiment and described with the X-axis, the Y-axis, and the Z-axis in FIGS. 1 to 3, in which the stacking direction is the Z axial direction, can be applied to a general embodiment by reading X-axis, the Y-axis, and the Z-axis as a second axis, a third axis, and a first axis, respectively, in a general embodiment.

In other words, the capacitance portion 14 is a region where the first internal electrode layers 12a connected to the first external electrode 20a and the second internal electrode layers 12b connected to the second external electrode 20b face each other, and is a region where a capacitance is generated in the multilayer ceramic capacitor 100. Specifically, the capacitance portion 14 is a region where the internal electrode layers, which are connected to different external electrodes and are adjacent to each other via the dielectric layer, face each other.

In the capacitance portion 14 in which the dielectric layers 11 and the internal electrode layers 12 are alternately stacked, the internal electrode layer 12 constitutes the outermost side of the capacitance portion 14 in the stacking direction (Z axial direction) of the capacitance portion 14. The cover layer 13 is arranged on the outer side of the capacitance portion 14 in the stacking direction, i.e., the outer surface of the outermost internal electrode layer 12 in the stacking direction. As described above, the multilayer ceramic capacitor of the present embodiment includes the capacitance portion 14, in which the dielectric layers 11 and the internal electrode layers 12 are alternately stacked, and the cover layer 13 arranged on the outer side of the capacitance portion in the stacking direction of the capacitance portion. In the example illustrated in FIGS. 1 to 3, an upper cover layer 13a arranged on an top surface of the capacitance portion 14 and a lower cover layer 13b arranged on a bottom surface of the capacitance portion 14 are included as the cover layers 13.

A configuration of the base body 10 is not limited to the configuration illustrated in FIGS. 1 to 3, as long as the first internal electrode layers 12a and the second internal electrode layers 12b are exposed in different regions of the surfaces of the base body 10, and are electrically connected to the different external electrodes. The different regions of the surfaces of the base body 10 may be respective surface regions of the surfaces facing each other among the surfaces of the base body 10, respective surfaces regions of the surfaces adjacent to each other, or different surface regions within the same surface. The different external electrodes may each extend from the respective surface, in which the first internal electrode layers 12a or the second internal electrode layers 12b are exposed to the surface region of the stack, to the other surface, as long as the different external electrodes are set apart from each other. The base body 10 may include intermediate regions between the dielectric layers 11 and the internal electrode layers 12, respectively.

The region where the first internal electrode layers 12a each connected to the first external electrode 20a face one another in the stacking direction without being blocked by the second internal electrode layers 12b connected to the second external electrode 20b is referred to as a first end margin 15a. Moreover, the region where the second internal electrode layers 12b each connected to the second external electrode 20b face one another in the stacking direction without being blocked by the first internal electrode layers 12a each connected to the first external electrode 20a is referred to as a second end margin 15b. Each end margin is a region in which the internal electrode layers connected to the same external electrode face one another in the stacking direction without being blocked by the internal electrode layers connected to the different external electrode. The first end margin 15a and the second end margin 15b are regions in which a capacitance is not generated.

In addition, as illustrated in FIG. 3, the region provided adjacent to and outside of the capacitance portion 14 in the Y axial direction is referred to as a side margin 16. The side margin 16 is an outer region adjacent to the capacitance portion 14 on the side where the internal electrode layers 12 are not led. The side margin 16 is also a region in which a capacitance is not generated.

The dimensions of the multilayer ceramic capacitor 100 are not particularly limited. For example, the dimensions of the multilayer ceramic capacitor 100 may be: 0.25 mm in length, 0.125 mm in width, and 0.125 mm in height; 0.4 mm in length, 0.2 mm in width, and 0.2 mm in height; 0.6 mm in length, 0.3 mm in width, and 0.3 mm in height; 1.0 mm in length, 0.5 mm in width, and 0.5 mm in height; 3.2 mm in length, 1.6 mm in width, and 1.6 mm in height; or 4.5 mm in length, 3.2 mm in width, and 2.5 mm in height. However, the dimensions of the multilayer ceramic capacitor 100 listed above are merely examples, and the multilayer ceramic capacitor is not limited to the above dimensions. The dimensions of the multilayer ceramic capacitor 100 may satisfy, for example, length>width≥height, width>length≥height, height>length≥width, or height>width≥length. The multilayer ceramic capacitor 100 illustrated in FIGS. 1 to 3 has a length in the X axial direction (the electrode extraction direction), a width in the Y axial direction, and a height in the Z axial direction (the stacking direction).

### (Dielectric Layer)

The dielectric layer 11 includes, as a main component, a ceramic material, and preferably includes a compound having a perovskite structure (may be also referred to as a perovskite compound) represented by a general formula ABO₃ as a main component. Moreover, the dielectric layer 11 may include the perovskite compound, for example, in an amount of 50 at % or greater, 60 at % or greater, 80 at % or greater, 90 at % or greater, or 95 at % or greater. The perovskite structure may be a structure in which oxygen is more deficient than in the stoichiometric composition. Specifically, the perovskite composition may be represented by ABO_{3-α} (0≤α≤1, where α is an amount deviated from the stoichiometric composition), which is deviated from the stoichiometric composition. In present specification, the phrase of including a predetermined substance “as a main component” means that the predetermined substance is included in the largest amount in terms of a ratio in the amount of substance (mol) relative to all substances included.

As the perovskite compound, barium titanate (BaTiO₃), calcium zirconate (CaZrO₃), calcium titanate (CaTiO₃), strontium titanate (SrTiO₃), magnesium titanate (MgTiO₃), Ba_{1-x-y}CaₓSr_{y}Ti_{1-z}Zr_{z}O₃ (0≤x≤1, 0≤y≤1, 0≤z≤1) forming a perovskite structure, or any combination of the foregoing can be used. Ba_{1-x-y}CaₓSr_{y}Ti_{1-z}Zr_{z}O₃ may be barium strontium titanate, barium calcium titanate, barium zirconate, barium zirconate titanate, calcium zirconate titanate, barium calcium zirconate titanate, or the like. The B-site of the perovskite compound may include hafnium (Hf).

Among the above compounds, barium titanate (BaTiO₃) is preferred. Since barium titanate has excellent dielectric characteristics, such as a high dielectric constant, a small dielectric loss, and the like, the capacitance of the multilayer ceramic capacitor 100 can be increased when the dielectric layer 11 includes barium titanate as a perovskite compound. The ceramic material of the dielectric layer 11 preferably includes barium titanate as a main component, and may be composed only of barium titanate.

The dielectric layer 11 may include additives other than the above-described ceramic material. Examples of the additives include simple substances or compounds each including one or more elements selected from the group consisting of zirconium (Zr), magnesium (Mg), manganese (Mn), molybdenum (Mo), vanadium (V), chromium (Cr), and rare earth elements (scandium (Sc), cerium (Ce), neodymium (Nd), yttrium (Y), samarium (Sm), europium (Eu), gadolinium (Gd), terbium (Tb), dysprosium (Dy), holmium (Ho), erbium (Er), thulium (Tm), and ytterbium (Yb)); simple substances or compounds each including one or more elements selected from the group consisting of cobalt (Co), nickel (Ni), lithium (Li), boron (B), sodium (Na), potassium (K), and silicon (Si); glass including an oxide including one or more elements selected from the group consisting of cobalt, nickel, lithium, boron, sodium, potassium, and silicon; and the like.

Among the above additives, a simple substance or compound including an element, such as manganese (Mn), magnesium (Mg), silicon (Si), boron (B), or the like, glass, or the like is known as an additive having a sintering promotion function (a sintering agent or a sintering aid). From the viewpoint of retention of dielectric characteristics of the multilayer ceramic capacitor 100, the dielectric layer 11 is preferably substantially free of the above additive having the sintering promotion function, and is particularly preferably free of Mn. In the present specification, the phrase “substantially free of” a predetermined element means that the number of atoms of the predetermined element is 0.001 or less, and preferably 0.0001 or less, relative to 100 atoms of the B-site element of the perovskite compound represented by the general formula ABO₃, which is a ceramic material. Even if the dielectric layer 11 includes the additive having the sintering promotion function, the additive des not substantially exert the sintering promotion function on the dielectric layer 11 as long as the atomic ratio is equal to or less than the above atomic ratio.

### (Internal Electrode Layer)

The internal electrode layer 12 includes a metal or an alloy as a main component. The internal electrode layer 12 includes, for example, a base metal, such as nickel (Ni), copper (Cu), tin (Sn), or the like, or an alloy including the base metal as a main component. The internal electrode layer 12 may include, as a main component, a noble metal, such as platinum (Pt), palladium (Pd), silver (Ag), gold (Au), or the like, or an alloy including the noble metal. The internal electrode layer 12 preferably includes Ni in view of excellent electrical characteristics, cost reduction, and the like, and may include Ni as a main component.

As described later, when an internal electrode layer 12 is formed during production of a multilayer ceramic capacitor, in the case where one or more elements selected from the group consisting of copper (Cu), gold (Au), silver (Ag), aluminum (Al), iridium (Ir), and tungsten (W) are added to an unfired internal electrode material for forming the internal electrode layers 12, the internal electrode may include one or more elements selected from the group consisting of Cu, Au, Ag, Al, Ir, and W. In the case where the unfired internal electrode material includes Cu, Cu may be included in the internal electrode layer 12. When the internal electrode layer 12 includes Ni as a main component, the internal electrode layer 12 may include an alloy of Ni and Cu.

### (Cover Layer)

The cover layer 13 includes a ceramic material as a main component. For the specific ceramic material of the cover layer 13, refer to the above-described ceramic material of the dielectric layer 11. Therefore, the cover layer 13 may include a perovskite compound represented by a general formula ABO₃. The cover layer 13 may include the perovskite compound represented by the general formula ABO₃, for example, in an amount of 50 at % or greater, 60 at % or greater, 80 at % or greater, 90 at % or greater, or 95 at % or greater. The perovskite compound is preferably barium titanate (BaTiO₃). Specifically, the cover layer 13 preferably includes barium titanate (BaTiO₃). Moreover, the ceramic material of the cover layer 13 preferably includes barium titanate as a main component, and may be composed only of barium titanate.

The ceramic material of the cover layer 13 may be the same as the ceramic material of the dielectric layer 11, or may be different. However, the cover layer 13 preferably includes the same ceramic material as the dielectric layer 11, because the number of materials prepared during production can be reduced, and characteristics are less likely to vary even when interdiffusion of the materials of the cover layer 13 and the dielectric layer 11 occurs. For example, both the ceramic material included in the cover layer 13 and the ceramic material included in the dielectric layer 11 preferably include barium titanate as a main component, and may be composed only of barium titanate.

The cover layer 13 includes one or more elements selected from the group consisting of copper (Cu), gold (Au), silver (Ag), aluminum (Al), iridium (Ir), and tungsten (W) in a metallic state. In the present specification, the term “metallic state” means that a metal is present in a state of a simple substance or an alloy. Since the cover layer 13 includes one or more elements selected from the group consisting of copper (Cu), gold (Au), silver (Ag), aluminum (Al), iridium (Ir), and tungsten (W) in a metallic state, rather than elements, compounds, glass, or the like known as additives having a sintering promotion function (a sintering agent or a sintering aid), such as a simple substance or a compound including an element, such as manganese (Mn), magnesium (Mg), silicon (Si), boron (B), or the like, thermal conductivity of the cover layer 13 can be increased. Owing to the above configuration, moisture resistance of the cover layer 13 can be improved, which in return, improves moisture resistance of the multilayer ceramic capacitor 100, and therefore a highly reliable multilayer ceramic capacitor 100 can be obtained. This is probably because the cover layer 13 including one or more elements selected from the group consisting of Cu, Au, Ag, Al, Ir, and W in a metallic state has high thermal conductivity during firing (described below), and therefore heat of a firing furnace is efficiently transferred to the entire cover layer 13 at high speed, thereby facilitating uniform densification of the cover layer 13. Since the heat of the firing furnace is efficiently transferred to the entire cover layer 13, a highly reliable multilayer ceramic capacitor can be produced even when a temperature of the firing furnace is set relatively low during firing, that is, when firing is performed at a relatively low firing temperature. The relatively low firing temperature contributes to facilitation of densification of the cover layer during firing. Since the heat of the firing furnace is transferred to the entire cover layer 13 at high speed, dielectric layers with little variation can be obtained even when a heating rate of the firing furnace is set high during firing, that is, even when firing is performed at a relatively high heating rate, and therefore a highly reliable multilayer ceramic capacitor can be produced. The relatively high heating rate can improve productivity as the heating time to perform firing can be shortened. Since the heating temperature is lowered and the heating time is shortened as described above, the amount of energy consumed during firing can be reduced, which is preferred in view of const reduction and sustainable development goals (SDGs) for achieving a sustainable society.

Among the above one or more element selected from the group consisting of Cu, Au, Ag, Al, Ir, and W, Cu is preferred because a simple substance or alloy of Cu has high thermal conductivity and is inexpensive.

Further, the number of atoms of the one or more elements selected from the group consisting of Cu, Au, Ag, Al, Ir, and W is 0.002 or greater and 0.15 or less, relative to 100 atoms of the B-site element of the perovskite compound, which is represented by the general formula ABO₃, included in the cover layer 13. The number of atoms may be preferably 0.002 or greater and 0.09 or less, more preferably 0.003 or greater and 0.075 or less, and yet more preferably 0.005 or greater and 0.05 or less. Since the number of atoms of the one or more elements selected from the group consisting of Cu, Au, Ag, Al, Ir, and W is 0.002 or greater relative to 100 atoms of the B-site element, the thermal conductivity of the cover layer 13 is increased to an appropriate level, and therefore a cover layer having excellent moisture resistance can be obtained, which can, in return, yield a multilayer ceramic capacitor 100 having excellent moisture resistance. Since the number of atoms of the one or more elements selected from the group consisting of Cu, Au, Ag, Al, Ir, and W is 0.15 or less relative to 100 atoms of the B-site element, electrical defects, such as current leakage or the like, can be minimized.

In the case where the perovskite compound represented by the general formula ABO₃ is barium titanate, the B-site element is Ti. In this case, the number of atoms of the one or more elements selected from the group consisting of Cu, Au, Ag, Al, Ir, and W in the cover layer 13 is 0.002 or greater and 0.15 or less relative to 100 Ti atoms. In the case where the perovskite compound is represented by Ba_{1-x-y}CaₓSr_{y}Ti_{1-z}Zr_{z}O₃ (0≤x≤1, 0≤y≤1, 0≤z≤1), the B-site element includes Ti and Zr. In this case, the number of atoms of the one or more elements selected from the group consisting of Cu, Au, Ag, Al, Ir, and W in the cover layer 13 is 0.002 or greater and 0.15 or less relative to 100 atoms of Ti and Zr in combination.

The one or more elements selected from the group consisting of Cu, Au, Ag, Al, Ir, and W included in the cover layer 13 in the predetermined amount may be derived from one or more elements added to an unfired cover material for forming the cover layers 13 during production of the multilayer ceramic capacitor 100, or may be one or more elements, which are added to an unfired internal electrode material for forming the internal electrode layers 12 and are diffused into the cover layer 13 during firing, or may include both.

The cover layer 13 may include an additive including an element other than the one or more elements selected from the group consisting of Cu, Au, Ag, Al, Ir, and W. Such an additive may be one or more additives described as the additives included in the dielectric layer 11. However, the amount of the additive having a sintering promoting function (additive known as a sintering agent) is preferably reduced in the cover layer 13. Since the additive having the sintering promotion function impairs dielectric characteristics of the multilayer ceramic capacitor 100, desired dielectric characteristics can be maintained by reducing the amount of the additive having the sintering promotion function.

For example, the number of atoms of manganese (Mn) serving as the additive having the sintering promotion function in the cover layer 13 is preferably 1.2 or less relative to 100 atoms of the B-site element of the perovskite compound represented by the general formula ABO₃. When the number of Mn atoms is in the above range, an amount of Mn diffused from the cover layer 13 into the capacitance portion 14 during firing can be reduced, and reduction in dielectric characteristics of the multilayer ceramic capacitor 100 can be minimized. Moreover, the number of Mn atoms is preferably 1.0 or less, more preferably 0.5 or less, yet more preferably 0.1 or less, yet further more preferably 0.05 or less, relative to 100 atoms of the B-site element. Further, the cover layer 13 is preferably substantially free of Mn.

Further, the number of atoms of an element of the additive having the sintering promotion function (the total number of atoms, when two or more elements are included), which includes Mn, in the cover layer 13 is preferably 1.2 or less relative to 100 atoms of the B-site element of the perovskite compound represented by the general formula ABO₃ included in the cover layer 13. When the number of atoms of the element of the additive having the sintering promotion function is within the above range, diffusion of the additive having the sintering promotion function from the cover layer 13 into the capacitance portion 14 during firing can be minimized, thereby further minimizing the reduction in the dielectric characteristics of the multilayer ceramic capacitor 100. The number of atoms of the element of the additive having the sintering promotion function is preferably 1.0 or less, more preferably 0.5 or less, yet more preferably 0.1 or less, and yet further more preferably 0.05 or less, relative to 100 atoms of the B-site element. Moreover, the cover layer 13 is preferably substantially free of the additive having the sintering promotion function.

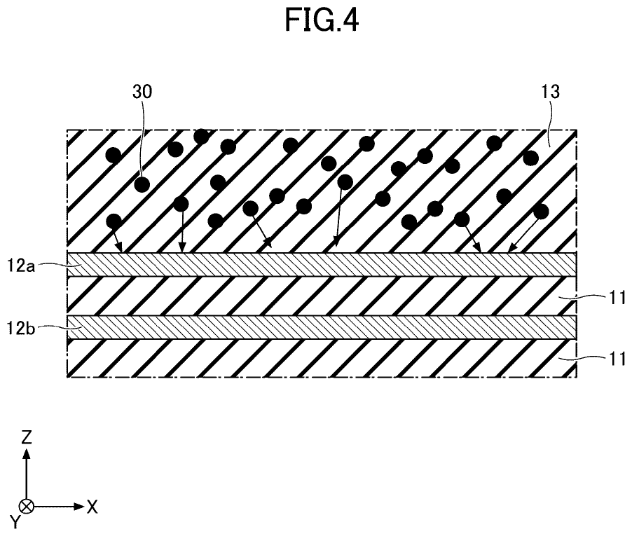

A substance including one or more elements selected from the group consisting of Cu, Au, Ag, Al, Ir, and W, which is present in the cover layer 13, is diffused toward the capacitance portion 14 during firing. Once the one or more elements reach the internal electrode layer 12 in contact with the cover layer 13, the one or more elements form an alloy with a metal constituting the internal electrode layer 12, and therefore the one or more elements are not likely to be diffused into the inner part of the capacitance portion 14. FIG. 4 schematically illustrates an enlarged view of the section C of FIG. 2. As illustrated in FIG. 4, the substance 30 including one or more elements selected from the group consisting of Cu, Au, Ag, Al, Ir, and W is diffused toward the center in the stacking direction (Z axial direction), but the diffusion is inhibited by the outermost internal electrode layer 12, in which an alloy is formed, in the stacking direction, and therefore the substance 30 is less likely to be diffused further in the stacking direction. Accordingly, reduction in the capacitance characteristics caused by addition of a substance including one or more elements selected from the group consisting of Cu, Au, Ag, Al, Ir, and W, particularly a substance including Cu, can be inhibited.

Among the internal electrode layers 12, the concentration of the one or more elements selected from the group consisting of Cu, Au, Ag, Al, Ir, and W in the uppermost internal electrode layer, the lowermost internal electrode layer, or both in the vicinity of the cover layer 13 is higher than the concentration of the one or more elements in the internal electrode layer located in the central part of the capacitance portion in the stacking direction.

In the case where one or more elements selected from the group consisting of Cu, Au, Ag, Al, Ir, and W included in the cover layer 13 are derived only from one or more elements added to an unfired cover material for forming a cover layer 13 during production of a multilayer ceramic capacitor 100, among the internal electrode layers 12, a concentration of the substance including one or more elements selected from the group consisting of Cu, Au, Ag, Al, Ir, and W in the internal electrode layer in the vicinity of the cover layer 13, i.e., the uppermost internal electrode layer, the lowermost internal electrode layer, or both, is higher than the concentration of the substance in the internal electrode layer located in the central part of the capacitance portion in the stacking direction, for example, by two times or greater, and preferably three times or greater. Further, the internal electrode layer located in the central part of the capacitance portion in the stacking direction is preferably substantially free of one or more elements selected from the group consisting of Cu, Au, Ag, Al, Ir, and W. For example, the number of atoms of one or more elements selected from the group consisting of Cu, Au, Ag, Al, Ir, and W in the internal electrode layer located in the central part of the capacitance portion in the stacking direction is preferably 0.001 or less, and more preferably 0.0001 or less relative to 100 atoms of a main component element of the internal electrode layer located in the central part of the capacitance portion in the stacking direction.

One or more elements selected from the group consisting of Cu, Au, Ag, Al, Ir, and W included in the cover layer 13 may be derived from one or more elements added to an unfired internal electrode material for forming the internal electrode layers 12, that is, may be one or more elements that are added to an unfired internal electrode material and are diffused into the cover layer 13 during firing.

As one example, one or more elements selected from the group consisting of Cu, Au, Ag, Al, Ir, and W included in the cover layer may be one or more elements added only to an internal electrode material for forming an internal electrode layer in the vicinity of the cover layer 13 among internal electrode materials for forming internal electrode layers 12. In this case, one or more elements selected from the group consisting of Cu, Au, Ag, Al, Ir, and W are not added to an internal electrode layer located in a central part of the capacitance portion in the stacking direction before firing. Therefore, among the internal electrode layers 12, the concentration of one or more elements selected from the group consisting of Cu, Au, Ag, Al, Ir, and W in the internal electrode layer in the vicinity of the cover layer, for example, the uppermost internal electrode layer, the lowermost internal electrode layer, or both can be made higher than the concentration of the one or more elements in the internal electrode layer located in the central part of the capacitance portion in the stacking direction even after firing. Moreover, the internal electrode layer located in the central part of the capacitance portion in the stacking direction is preferably free of the one or more elements selected from the group consisting of Cu, Au, Ag, Al, Ir, and W even after firing. The phrase “substantially free of” encompasses that the number of atoms of the one or more elements selected from the group consisting of Cu, Au, Ag, Al, Ir, and W may be preferably 0.001 or less, and more preferably 0.0001 or less, relative to 100 atoms of a main component element of the internal electrode layer located in the central part of the capacitor portion.

As a modified example, dummy electrodes may be disposed as internal electrode layers in the vicinity of the cover layer 13, and one or more elements selected from the group consisting of Cu, Au, Ag, Al, Ir, and W may be added to an internal electrode material for forming the dummy electrodes. In this case, the one or more elements added to the unfired internal electrode material are also diffused into the cover layer 13 during firing. The dummy electrodes may be defined as a pair of electrode layers adjacent to each other via a dielectric layer and connected to the same external electrode, among the internal electrode layers. Since no potential difference is generated between the pair of the electrodes, the dummy electrodes do not contribute to the capacitance. Even in the case where dummy electrodes are disposed as internal electrode layers in the vicinity of the cover layer 13, similar to the case of typical internal electrode layers, a concentration of one or more elements selected from the group consisting of Cu, Au, Ag, Al, Ir, and W in the upper dummy electrode, the lower dummy electrode, or both in the vicinity of the cover layer 13 can be made higher than the concentration of the one or more elements in the internal electrode layer located in the central part of the capacitance portion in the stacking direction. The internal electrode layer located in the central part of the capacitance portion in the stacking direction is preferably substantially free of one or more elements selected from the group consisting of Cu, Au, Ag, Al, Ir, and W even after firing. The phrase “substantially free of” encompasses that the number of atoms of the one or more elements selected from the group consisting of Cu, Au, Ag, Al, Ir, and W may be preferably 0.001 or less, and more preferably 0.0001 or less, relative to 100 atoms of a main component element of the internal electrode layer located in the central part of the capacitance portion in the stacking direction.

Among the internal electrode layers 12, the concentration of the one or more elements selected from the group consisting of Cu, Au, Ag, Al, Ir, and W in the uppermost internal electrode layer, the lowermost internal electrode layer, or both in the vicinity of the cover layer 13 may be lower than the concentration of the one or more elements in the internal electrode layer located in the central part of the capacitance portion in the stacking direction.

In the case where one or more elements selected from the group consisting of Cu, Au, Ag, Al, Ir, and W included in the cover layer are derived from one or more elements added to an unfired internal electrode material for forming the internal electrode layers 12, specifically, one or more elements selected from the group consisting of Cu, Au, Ag, Al, Ir, and W included in the cover layer include one or more elements that are added to an unfired internal electrode material and are diffused into the cover layer 13 during firing, among the internal electrode layers 12, a concentration of the one or more elements selected from the group consisting of Cu, Au, Ag, Al, Ir, and W in the internal electrode layer located in the central part of the capacitance portion in the stacking direction may be higher, for example, by 1.1 times or greater, preferably 1.5 times or greater, more preferably 2 times or greater, and yet more preferably 4 times or greater, than the concentration of the one or more elements in the internal electrode layer 12 in the vicinity of the cover layer 13, i.e., the uppermost internal electrode layer, the lowermost internal electrode layer, or both. This is because, even if an amount of a substance including one or more elements selected from the group consisting of Cu, Au, Ag, Al, Ir, and W is the same in each internal electrode layer 12 before diffusion starts, once diffusion starts, the majority of the substance is rarely diffused into the cover layer 13 and remains in the internal electrode layer 12 that is not in the vicinity of the cover layer 13, whereas an amount of the substance diffused into the cover layer 13 is increased and the residual amount of the substance is significantly reduced in the internal electrode layer 12 in the vicinity of the cover layer 13 among the internal electrode layers 12.

The number of atoms of the predetermined element relative to 100 atoms of the B-site of the perovskite compound represented by the general formula ABO₃ in the cover layer 13 can be calculated by analyzing a cross-section of the obtained multilayer ceramic capacitor. For example, the multilayer ceramic capacitor is polished from the side of the external electrode 20 to the center, specifically, along the X axial direction toward the vicinity of the center in the X axial direction, to expose a Y-Z cross-section, and a center portion of the cover layer 13 in the Z axial direction is subjected to elemental analysis. In the case where the perovskite compound included in the cover layer 13 is barium titanate, the number of atoms of the predetermined element relative to 100 Ti atoms is determined. The amount of the predetermined element can be determined based on analysis of wavelength dispersive X-ray spectroscopy (EPMA-WDX), or may be determined by analysis of laser ablation-inductively coupled plasma mass spectrometry (LA-ICP-MS). If there is the inconsistency in the results, the measured value of the wavelength dispersive X-ray spectroscopy is used. An amount of the elements in a layer other than the cover layer 13, for example, the internal electrode layer 12, can be also determined in the same manner.

The embodiment of the multilayer ceramic capacitor 100 has been described above, and a configuration of the multilayer ceramic capacitor of the present disclosure can be used as a multilayer ceramic electronic component. Specific examples of the multilayer ceramic electronic component other than the multilayer ceramic capacitor include chip varistors, chip thermistors, and the like.

### [Method of Producing Multilayer Ceramic Capacitor]

Next, a method of producing the above-described multilayer ceramic capacitor 100 will be described. The production method according to one embodiment of the present disclosure is a method of producing a multilayer ceramic capacitor that includes a capacitance portion, in which dielectric layers and internal electrode layers are alternately stacked, and a cover layer arranged on an outer side of the capacitance portion in a stacking direction of the capacitance portion, where the cover layer includes a perovskite compound represented by a general formula ABO₃. The method includes: alternate arranging of an unfired dielectric material for forming the dielectric layers and an unfired internal electrode material for forming the internal electrode layers, and arranging of an unfired cover material for forming the cover layers, thereby obtaining a stack; and firing of the stack. After the firing, the cover layer includes one or more elements selected from the group consisting of Cu, Au, Ag, Al, Ir, and W in a metallic state, and a number of atoms of the one or more elements is 0.002 or greater and 0.15 or less relative to 100 atoms of the B-site element.

### First Embodiment

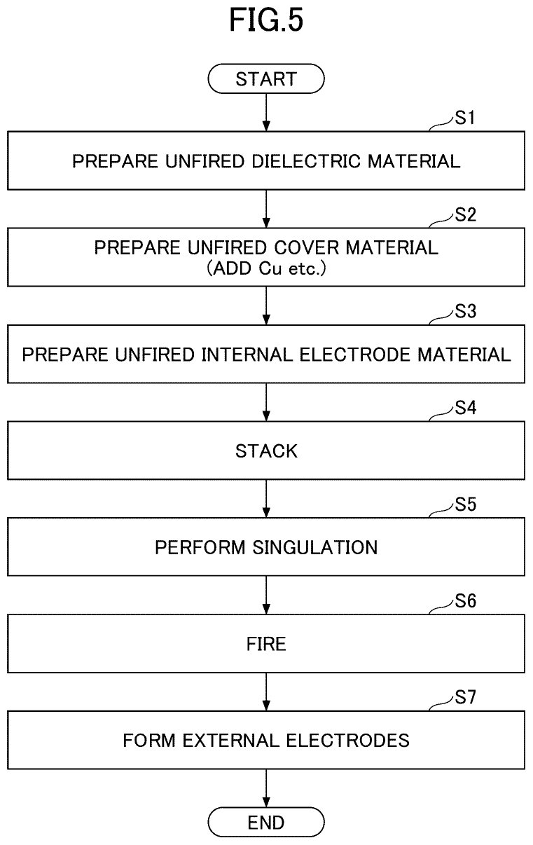

The production method according to the first embodiment includes formation of the unfired cover material by adding one or more elements selected from the group consisting of Cu, Au, Ag, Al, Ir, and W. In the first embodiment, the one or more elements selected from the group consisting of Cu, Au, Ag, Al, Ir, and W are present in the cover layer 13 even before firing, and therefore a predetermined amount of the one or more elements selected from the predetermined group can be assuredly included in the cover layer 13 of the multilayer ceramic capacitor 100 after firing. FIG. 5 is a flowchart exemplifying the method of producing the multilayer ceramic capacitor 100 according to the first embodiment.

### (Preparation of Unfired Dielectric Material (S1))

In preparation of an unfired dielectric material (S1), a ceramic green sheet (unfired dielectric material) that will be transformed into a dielectric layer 11 by firing is prepared.

First, a ceramic powder for forming dielectric layers is prepared. As the ceramic powder, a powder of the above-described ceramic material for the dielectric layers 11 of the multilayer ceramic capacitor 100 can be used. Accordingly, the ceramic powder can include a powder of a perovskite compound represented by a general formula ABO₃, and preferably includes barium titanate. The barium titanate can be generally obtained by reacting a titanium raw material, such as titanium dioxide or the like, with a barium raw material, such as barium carbonate or the like. Examples of a synthesis method for the ceramic powder. which will become a ceramic material that is a main component of a dielectric layer 11, include methods available in the related art, such as a solid phase method, a sol-gel method, a hydrothermal method, and the like.

Predetermined additives may be added to the ceramic powder for forming the dielectric layers according to the intended purpose. For example, an additive having a sintering promotion function (an additive known as a sintering aid) or the like may be added or may not be added. In view of improvement in dielectric characteristics of the multilayer ceramic capacitor 100, the ceramic powder for forming the dielectric layers is substantially free of the additive having the sintering promotion aid, and is particularly preferably free of Mn.

The ceramic powder for forming the dielectric layer is wet-mixed with or without an additive, dried, and then pulverized. A binder, such as a polyvinyl butyral (PVB) resin or the like, an organic solvent, such as ethanol, toluene, or the like, and a plasticizer are added to the obtained powder for forming the dielectric layers, and the resultant mixture is wet-mixed to prepare slurry for forming dielectric layers. In the case where an additive is added, the additive may not be added to the ceramic powder for forming the dielectric layers in advance, or may be added during preparation of the slurry. The obtained slurry for forming the dielectric layers is applied onto a base material, such as a polyethylene terephthalate (PET) film or the like, by die coating, doctor blade coating, or the like, followed by drying, thereby obtaining a ceramic green sheet (an unfired dielectric layer material).

### (Preparation of Unfired Cover Material (S2))

In the preparation of an unfired cover material (S2), a cover sheet (an unfired cover material) that will become a cover layer is prepared.

A ceramic powder for forming cover layers may be the same ceramic powder as the ceramic powder for forming the dielectric layers described in the preparation of the unfired dielectric material (S1). Accordingly, the ceramic powder may include a powder of a perovskite compound represented by a general formula ABO₃, and preferably includes barium titanate. Moreover, the same powder as the ceramic powder for forming the dielectric layers can be used.

As an additive, one or more elements selected from the group consisting of Cu, Au, Ag, Al, Ir, and W are added to the ceramic powder for forming the cover layers. The among the above elements, Cu is preferably added. The above one or more elements may be added in the form of a simple substance, an alloy, a compound, or an organic complex, but are preferably added in the form of an oxide because of easy handling, and uniform arrangement due to diffusion during firing. In the case of Cu, for example, a surface-oxidized copper (Cu) powder or copper oxide (CuO or Cu₂O) powder having a particle size of 500 nm or less is preferably used.

As described above, one or more elements selected from the group consisting of Cu, Au, Ag, Al, Ir, and W are added to the ceramic powder for forming the cover layers in the preparation of the unfired cover material (S2), and therefore moisture resistance can be improved, electrical defects such as current leakage can be minimized, and a highly reliable multilayer ceramic capacitor 100 can be obtained.

As described above, the predetermined one or more elements are added to the unfired cover material, and therefore a multilayer ceramic capacitor 100 that includes the cover layer 13 including the one or more elements selected from the group consisting of Cu, Au, Ag, Al, Ir, and W in a metallic state, where the number of atoms of the one or more elements is 0.002 or greater and 0.15 or less relative to 100 atoms of the B-site element of the compound represented by the general formula ABO₃ serving as a main component of the cover layer 13, can be obtained after firing (S6). In other words, an amount of the predetermined one or more elements to be included in the slurry for forming the cover layers can be set in the preparation of the unfired cover material (S2) so that the above-described configuration of the multilayer ceramic capacitor 100 in which the cover layer 13 includes the predetermined amount of the predetermined one or more elements in a metallic state can be obtained.

An amount of the one or elements added to the unfired cover material in the preparation of the unfired cover material (S2) may be such an amount with which the number of atoms of the one or more elements is 0.2 or greater and 5.0 or less, and preferably 0.4 or greater and 4.5 or less, relative to 100 atoms of the B-site element of the perovskite compound represented by the general formula ABO₃. The number of atoms of the one or more elements selected from the group consisting of Cu, Au, Ag, Al, Ir, and W may be preferably 4.0 or less, and more preferably 2.0 or less, relative to 100 atoms of the B-site element. Since the number of atoms of the one or more elements selected from the group consisting of Cu, Au, Ag, Al, Ir, and W is set to 0.2 or greater relative to 100 atoms of the B-site element, moisture resistance of the cover layer 13 can be improved, which can, in turn, improves moisture resistance of the multilayer ceramic capacitor 100 itself. Since the number of atoms of the one or more elements selected from the group consisting of Cu, Au, Ag, Al, Ir, and W is set to be 5.0 or less relative to 100 atoms of the B-site element, electrical defects, such as current leakage, can be minimized. Therefore, a highly reliable multilayer ceramic capacitor 100 can be obtained.

In the case where the perovskite compound represented by the general formula ABO₃ is barium titanate (BaTiO₃) and the one or more elements is Cu, the amount of Cu in the slurry for forming the cover layer is such an amount with which the number of Cu atoms is 0.2 or greater and 5.0 or less, and preferably 0.4 or greater and 4.5 or less, relative to 100 Ti atoms.

An additive having a sintering promotion function (an additive known as a sintering agent) is preferably not added to the ceramic powder for forming the cover layer. Even when the additive having the sintering promotion function is added, a small amount of the additive having the sintering promotion function is preferably added. Since the additive having the sintering promotion function impairs the dielectric characteristics of the multilayer ceramic capacitor 100, the dielectric characteristics of the multilayer ceramic capacitor 100 can be maintained by reducing the amount of the additive having the sintering promotion function. Even when Mn is added to the ceramic powder for forming the cover layers, for example, the number of Mn atoms is preferably 1.5 or less relative to 100 atoms of the B-site element of the perovskite compound represented by the general formula ABO₃. Since the amount of Mn is within the above range, when Mn is diffused from the cover layer 13 into the capacitance portion 14 during firing (S6), reduction in dielectric characteristics of the multilayer ceramic capacitor 100 can be minimized. Moreover, the number of Mn atoms in the ceramic powder for forming the cover layers may be preferably 1.0 or less, and more preferably 0.5 or less relative to 100 atoms of the B-site element. Further, the ceramic powder for forming the cover layers is preferably substantially free of Mn.

As in the preparation of the unfired dielectric material (S1), the ceramic powder for forming the cover layers is wet-mixed with a binder, an organic solvent, and a plasticizer, thereby preparing slurry for forming cover layers. The obtained slurry for forming the cover layers is applied onto a base material, such as a polyethylene terephthalate (PET) film or the like, by die coating, doctor blade coating, or the like, followed by drying, thereby obtaining a cover sheet (an unfired cover layer).

### (Preparation of Unfired Internal Electrode Material (S3))

In the preparation of an unfired internal electrode material (S3), an unfired internal electrode material, which will become internal electrode layers 12, i.e., first internal electrode layers 12a and second internal electrode layers 12b, is prepared. A metal serving as a main component of the unfired internal electrode material may be the same metal material as the metal material described in the internal electrode layer 12 of the multilayer ceramic capacitor 100. For example, the metal material may be a base metal, such as Ni, Sn, or the like, or an alloy including any of the foregoing. Moreover, a noble metal, such as Pt, Pd, Ag, Au, or the like, or an alloy including any of the foregoing may be used. In view of excellent electrical characteristics and cost reduction, the metal material preferably includes Ni, and more preferably includes Ni as a main component.

The above metal material can be kneaded with an organic binder and a solvent, thereby obtaining a metal paste (an unfired internal electrode material).

As a co-material, a ceramic powder may be added to the metal paste. A main component of the ceramic powder is not particularly limited, but the co-material has preferably the same composition as the composition of the ceramic powder used in the preparation of the unfired dielectric material (S1), the preparation of the unfired cover material (S2), or both, or is preferably formed of the same constituent elements. In the case where the ceramic powder is added as a co-material, the ceramic powder can be added during kneading of the metal paste.

### (Stacking (S4))

In the stacking (S4), the metal paste prepared in the preparation of the unfired internal electrode material (S3) is printed on surfaces of the ceramic green sheets obtained in the preparation of the unfired dielectric material (S1) by screen printing, gravure printing, or the like. As a result, a first internal electrode pattern that will become a first internal electrode layer 12a or a second internal electrode pattern that will become a second internal electrode layer 12b is provided on the surface of the ceramic green sheet. The formation method of the internal electrode patterns is not limited to printing, and the internal electrode pattern may be formed by performing plating, vacuum vapor deposition, sputtering, CVD, or the light through a mask.

The ceramic green sheets on each of which the metal paste has been printed are stacked in a manner such that the internal electrode layers 12 are alternately led to a pair of external electrodes 20a and 20b arranged in a longitudinal direction (X axial direction) of the dielectric layers 11. The stacking may be performed by any technique available in the related art. For example, in order to form a side margin 16, which will become a region outside the capacitance portion 14 in the Y axial direction, on the side where the internal electrode layer 12 is not led, an unfired dielectric material can be provided in a periphery region where an internal electrode pattern formed of the metal paste is not printed. As a stack unit of the ceramic green sheets on each of which the metal paste has been printed, the number of the ceramic green sheets stacked per stack unit can be 100 layers to 500 layers.

Subsequently, the cover sheets obtained in the preparation of the unfired cover material (S2) are respectively stacked on the top and bottom of the stack including the ceramic green sheets and the internal electrode patterns, i.e., the upper side and lower side of the stack in the stacking direction (the Z axial direction). The number of the cover sheets stacked on each side may be 2 layers to 10 layers.

The stack in which the cover sheets are stacked can be pressed in the stacking direction (the Z axial direction), thereby obtaining a compact.

### (Singulation (S5))

Further, the compact can be cut into a predetermined size by dicing with a dicer, laser cutting, or the like to be separated into a single piece. As a method for the singulation, any technique available in the related art can be appropriately used.

### (Firing (S6))

In firing, the singulated piece of the stack is fired. First, heating is performed in an N₂ atmosphere at approximately 300° C. or higher and approximately 600° C. or lower for 2 hours or longer and 10 hours or shorter for degreasing. In the first embodiment, firing is subsequently performed in a strong reducing atmosphere including a hydrogen concentration of 0.08 vol % or greater and 1.0 vol % or less, and preferably 0.1 vol % or greater and 0.5 vol % or less. The composition of the strong reducing atmosphere other than hydrogen includes nitrogen or argon. The above firing may be also referred to as main firing or strong reduction firing. The above firing facilitates transformation of the one or more elements (one or more elements selected from the group consisting of Cu, Au, Ag, Al, Ir, and W) added to the unfired materials into a metallic state, i.e., a metallic simple substance or an alloy. In the case where Cu is added as the one or more elements in the form of an oxide, copper oxide is reduced to be a Cu metal. As a result, a state in which an additive, which is a metallic simple substance or an alloy, is dispersed in the cover layer 13, is formed.

A firing temperature for the strong reduction firing is a relatively low temperature, and may be preferably 900° C. or higher and 1, 270° C. or lower, more preferably 1,000° C. or higher and 1, 250° C. or lower yet more preferably 1, 100° C. or higher and 1, 200° C. or lower, and yet further more preferably 1, 120° C. or higher and 1, 150° C. or lower. The firing performed at the above low temperatures is preferred in view of low energy consumption. The firing temperature in the above range can facilitate densification of the cover layer 13. Moreover, the relatively low firing temperature is preferred also in view of energy efficiency. The term “firing temperature” encompasses a temperature of a firing furnace. The heating rate during firing can be set to 20,000° C./h or greater and 30,000° C./h or less. Moreover, a firing time of the firing (S6) of the first embodiment may be 30 minutes or longer and two hours or shorter, which includes the process of elevating and lowering the temperature.

### (Formation of External Electrode (S7))

In the formation of external electrodes, a first external electrode 20a and a second external electrode 20b can be formed by plating or the like. In this manner as described above, production of a multilayer ceramic capacitor 100 is completed.

Although the first embodiment has been described in detail above, the present disclosure is not limited to a specific embodiment, and various modifications and changes can be made within the scope described in the claims. For example, after degreasing, metal films serving as base layers of respective external electrodes may be formed, strong reduction firing may be performed to sinter the base layers of the external electrodes at the same time as firing of the dielectric portions, and plating may be performed on the base layers of the external electrodes in the formation of the external electrodes, thereby forming final external electrodes.

### Second Embodiment

The production method according to the second embodiment includes formation of an unfired internal electrode material by adding one or more elements selected from the group consisting of Cu, Au, Ag, Al, Ir, and W. Specifically, in the second embodiment, one or more elements selected from the group consisting of Cu, Au, Ag, Al, Ir, and W are added in the preparation of the unfired internal electrode material (S3). Since the predetermined one or more elements, such as Cu or the like, is added in the preparation of the unfired internal electrode material (S3), the firing (S6) includes pre-firing (weak reduction firing (S6a)) and main firing (strong reduction firing (S6b)).

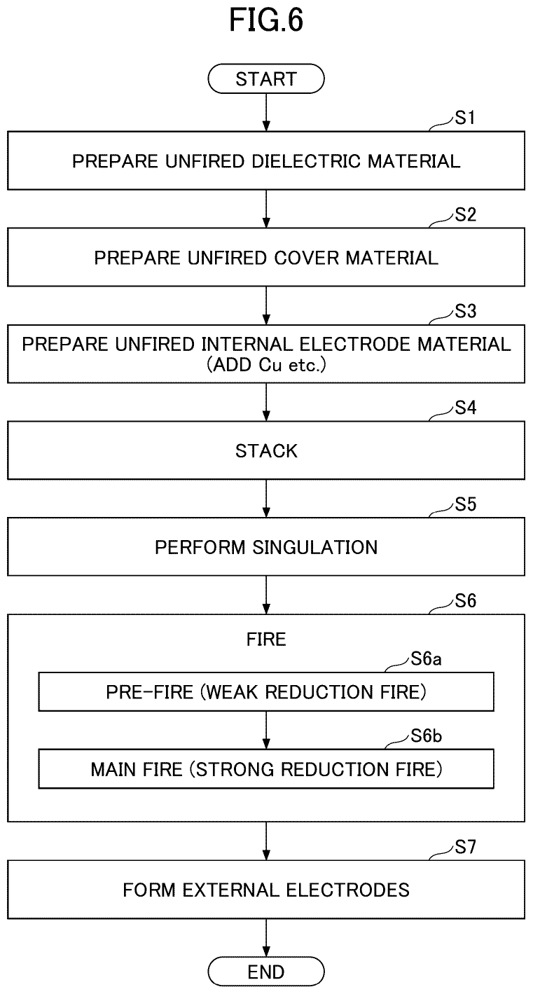

FIG. 6 is a flowchart exemplifying the method of producing the multilayer ceramic capacitor 100 according to the second embodiment. In the production method of the second embodiment, preparation of an unfired dielectric material (S1), stacking (S4), singulation (S5), and formation of external electrodes (S7) are the same as S1, S4, S5, and S7 of the first embodiment. Among the processes of the production method of the second embodiment, the processes different from the first embodiment will be described hereinafter. As in the first embodiment, the present disclosure is not limited to a specific embodiment in the second embodiment, various modifications and changes can be made within the scope described in the claims. For example, after degreasing, metal films serving as base layers of respective external electrodes may be formed, strong reduction firing may be performed to sinter the base layers of the external electrodes at the same time as firing of the dielectric portions, and plating may be performed on the base layers of the external electrodes in the formation of the external electrodes, thereby forming final external electrodes, as in the first embodiment.

### (Preparation of Unfired Cover Material (S2))

As described above, one or more elements selected from the group consisting of Cu, Au, Ag, Al, Ir, and W, preferably Cu, is added as an additive in the preparation of the unfired cover material (S2) in the first embodiment. However, the above addition is omitted in the preparation of the unfired cover material (S2) of the second embodiment. Other features are the same as the features of the preparation of the unfired cover material (S2) of the first embodiment.

### (Preparation of Unfired Internal Electrode Material (S3))

In the preparation of the unfired internal electrode material (S3), one or more elements selected from the group consisting of Cu, Au, Ag, Al, Ir, and W are added to a metal serving as a main component of the unfired internal electrode material, such as a base metal (e.g., Ni, Sn, etc.), or an alloy including any of the foregoing, thereby preparing a metal paste. Among the above one or elements, Cu is preferred in view of high thermal conductivity, low cost, or the like. In order to facilitate diffusion of Cu into a cover layer, a copper oxide (CuO or Cu₂O) powder having a particle size of 500 nm or less is preferably used, but Cu is not limited to the copper oxide. A surface-oxidized copper (Cu) powder or a Cu resinate may be used.

Alternatively, the metal including one or more elements selected from the group consisting of Cu, Au, Ag, Al, Ir, and W may be formed on a ceramic green sheet by sputtering in the stacking (S4) without adding the metal including one or more elements selected from the group consisting of Cu, Au, Ag, Al, Ir, and W to the metal paste. In the case where sputtering is performed, a common target for Ni and Cu/Cu₂O/CuO may be used, or separate targets may be used to perform sputtering simultaneously. For example, after printing an Ni paste, the metal including the above one or more elements, such as Cu/Cu₂O/Cu or the like, may be deposited on the metal pattern of the Ni paste by sputtering or the like. In the second embodiment, one or more elements selected from the group consisting of Cu, Au, Ag, Al, Ir, and W are added to all layers of the unfired internal electrode material to be stacked in the stacking (S4).

The one or more elements selected from the group consisting of Cu, Au, Ag, Al, Ir, and W added to the unfired internal electrode material are diffused into an adjacent layer in the firing (S6).

By adding the one or more elements as described above, the cover layer 13 includes one or more elements selected from the group consisting of Cu, Au, Ag, Al, Ir, and W in a metallic state after the firing (S6), and a configuration where the number of atoms of the one or more elements is 0.002 or greater and 0.15 or less relative to 100 atoms of the B-site element of the compound represented by the general formula ABO₃ is obtained. Accordingly, a highly reliable multilayer ceramic capacitor 100 that minimizes electrical defects, such as current leakage, and has excellent moisture resistance can be obtained. In other words, an amount of the predetermined one or more elements added to the unfired internal electrode material can be set in the preparation of the unfired internal electrode material (S3) so that the above-described multilayer ceramic capacitor 100 including the cover layer 13 that includes the predetermined amount of the predetermine one or elements in a metallic state is obtained.

The amount of the one or more elements selected from the group consisting of Cu, Au, Ag, Al, Ir, and W in the unfired internal electrode material may be an amount with which the number of atoms of the one or more elements selected from the group consisting of Cu, Au, Ag, Al, Ir, and W is 0.1 or greater and 10.0 or less relative to 100 atoms of the main component element of the unfired internal electrode material. The number of atoms of the one or more elements may be preferably 0.5 or greater and 5.0 or less, and more preferably 1.0 or greater and 3.0 or less relative to 100 atoms of the main component element. Since the number of atoms of the one or more elements is 0.1 or greater relative to 100 atoms of the main component element, moisture resistance of the cover layer 13 can be improved, which can, in turn, improve moisture resistance of the multilayer ceramic capacitor 100 itself. Since the number of atoms of the above one or more elements is 10.0 or less relative to 100 atoms of the above main component element (e.g., Ni), electrical defects, such as current leakage, can be minimized. Accordingly, a highly reliable multilayer ceramic capacitor 100 can be obtained.

In the case where a main component of the unfired internal electrode material is Ni and the one or more elements selected from the group consisting of Cu, Au, Ag, Al, Ir, and W is Cu, the number of Cu atoms is 0.3 or greater and 8.0 or less relative to 100 Ni atoms.

Other features are the same as the features of the preparation of the unfired internal electrode material (S3) of the first embodiment.

### (Firing (S6))

Since one or more elements selected from the group consisting of Cu, Au, Ag, Al, Ir, and W are added in the preparation of the unfired internal electrode material (S3) in the production method of the second embodiment as described above, the one or more elements are preferably sufficiently diffused from the internal electrode layers 12 into the cover layers 13. To this end, in the firing (S6) of the second embodiment, pre-firing (weak reduction firing (S6a)) is performed before the firing (S6) of the first embodiment, i.e., main firing.

### =Pre-Firing (Weak Reduction Firing (S6a))=

The stack obtained after the singulation (S5) is fired in a weak reducing atmosphere including a hydrogen concentration of 0.01 vol % or greater and 0.08 vol % or less, and preferably 0.02 vol % or greater and 0.05 vol % or less. The firing temperature of the pre-firing (S6a) is lower than the firing temperature of the main firing (S6b), and may be preferably 600° C. or higher and 950° C. or lower, more preferably 700° C. or higher and 900° C. or lower, and yet more preferably 750° C. or higher and 850° C. or lower. The firing time of the pre-firing (S6a) may be 10 minutes or longer and 2 hours or shorter.

Since the pre-firing (S6a) is performed, the one or more elements selected from the group consisting of Cu, Au, Ag, Al, Ir, and W included in the unfired internal electrode material can be diffused into the cover layers 13.

### =Main Firing (Strong Reduction Firing (S6b))=

The main firing is the same as the firing (S6) in the production method of the first embodiment.

The pre-firing (S6a) and the main firing (S6b) are consecutively performed. Specifically, the pre-firing (S6a) and the main firing (S6b) are performed by changing the hydrogen concentration in the firing furnace and the temperature of the firing furnace without taking the singulated green body out from the firing furnace.

### Third Embodiment

The production method of the third embodiment includes addition of one or more elements selected from the group consisting of Cu, Au, Ag, Al, Ir, and W to an unfired internal electrode material for forming internal electrode layers 12, similar to the second embodiment. However, the production method of the third embodiment includes addition of one or more elements selected from the group consisting of Cu, Au, Ag, Al, Ir, and W only to an unfired internal electrode material for forming internal electrode layers in the vicinity of the cover layers.

As a modified example of the third embodiment, internal electrode layers in the vicinity of the cover layer may be formed as dummy electrodes, and one or more elements selected from the group consisting of Cu, Au, Ag, Al, Ir, and W may be added only to the dummy electrodes. The dummy electrodes are, among the internal electrode layers, a pair of electrode layers that are adjacent to each other via a dielectric layer and are connected to the same external electrode. Since no potential difference is generated between the pair of electrode serving as the dummy electrodes, the dummy electrodes are the electrodes that do not contribute to capacitance.

In the third embodiment, an unfired internal electrode material to which one or more elements selected from the group consisting of Cu, Au, Ag, Al, Ir, and W are added, and an unfired internal electrode material to which one or more elements selected from the group consisting of Cu, Au, Ag, Al, Ir, and W are not added are prepared in the preparation of the unfired internal electrode material (S3). In the stacking (S4), the order of stacking is determined so that one or more elements selected from the group consisting of Cu, Au, Ag, Al, Ir, and W are added only to the internal electrode layer material that will become the internal electrode layers in the vicinity of the cover layer, among the unfired internal electrode materials, or in the modified example, so that the internal electrode layers in the vicinity of the cover layer act as dummy electrodes, and one or more elements selected from the group consisting of Cu, Au, Ag, Al, Ir, and W are only added to the dummy electrodes.

Moreover, similar to the second embodiment, the firing (S6) includes pre-firing (weak reduction firing (S6a)) and main firing (Strong reduction firing (S6b)) in connection with addition of the predetermined one or more elements, such as Cu or the like, in the preparation of the unfired internal electrode material (S3). Other features are the same as the features of the first embodiment. FIG. 6 is a flowchart illustrating the production method of the third embodiment.

The production methods of the first to third embodiments have been specifically described above, but a production method other than the above embodiments can be used in the present disclosure as long as a multilayer ceramic capacitor that includes a cover layer including a perovskite compound represented by a general formula ABO₃ and including one or more elements selected from the group consisting of Cu, Au, Ag, Al, Ir, and W in a metallic state, in which the number of atoms of the above one or more elements is 0.002 or greater and 0.15 or less relative to 100 atoms of the B-site element, can be obtained. For example, among layers of the unfired internal electrode materials stacked in the stacking (S4), the above one or more elements may be added to the predetermined layer.

### EXAMPLES

The present disclosure will be more specifically described based on examples hereinafter.

### <Measurement and Evaluation>

### (Measurement of Cu Content and Mn Content in Cover Layer and the Like)

The produced multilayer ceramic capacitor was polished from the external electrode side toward the center (along the X axial direction) to expose a cross-section. Then, the element analysis was performed on the center of one of the cover layers in the Z axial direction by laser ablation-inductively coupled plasma mass spectrometry (LA-ICP-MS), and the number of Cu atoms relative to 100 Ti atoms, and the number of Mn atoms relative to 100 Ti atoms were calculated. The Cu content in the internal electrode layer was also measured and calculated in the same manner as the above.

### (Evaluation of Moisture Resistance)

After applying a voltage of 6.3 V to the produced multilayer ceramic capacitor for 500 hours in the environment of 40° C. in temperature and 90% RH in humidity, the insulation resistance of the multilayer ceramic capacitor was measured by an LCR meter (HP4284A, measured by Keysight Technologies). Note that the measurement of the insulation resistance was performed after leaving the multilayer ceramic capacitor to stand for 24 hours at room temperature (25° C.) and humidity of 40% RH. The case where the insulation resistance after the application of the voltage for 500 hours was 500 MΩ or greater was evaluated as “Good,” and the case where the insulation resistance after the application of the voltage for 500 hours was less than 500 MΩ was evaluated as “Poor.”

### (Measurement of Current Leakage)

The current value when a voltage of 9 V was applied to the produced multilayer ceramic capacitor at 125° C. was measured by an ampere meter (ADCMT 5450).

### (Measurement of Capacitance)

After leaving the produced multilayer ceramic capacitor to stand for 1 hours at 150° C., followed by leaving the multilayer ceramic capacitor to stand for 24 hours in a standard state (temperature of 25° C., 1 atm (atmospheric pressure)), the capacitance of the multilayer ceramic capacitor was measured by the LCR meter at a voltage of 0.5 V and a frequency of 1 kHz.

### 1. Example where Cu is Added to Ceramic Slurry for Forming Cover Layers

### Example 1-1

Ceramic slurry for forming cover layers, which included barium titanate as a main component, was prepared. To the ceramic slurry for forming cover layers, Cu was added so that the number of Cu atoms was 0.5 relative to 100 Ti atoms, and Mn was added so that the number of Mn atoms was 0.5 relative to 100 Ti atoms. Note that Cu was added in the form of an oxide (CuO), and Mn was added in the form of a carbonate (MnCO₃). Cover sheets that would become cover layers were produced using the ceramic slurry.

An Ni paste was printed on a dielectric green sheet that would become a dielectric layer containing barium titanate as a main component. A stack was prepared by stacking 500 sheets of the above dielectric green sheets on which the Ni paste had been printed, and the cover sheets were respectively disposed on the outer sides of the stack in the stacking direction. The resultant stack was cut into a predetermined size to obtain a green body. The obtained green body was subjected to degreasing in a N₂ atmosphere, and then a nickel paste that would become base layers of external electrodes was applied by dip coating, thereby obtaining a green body (unfired green body).

The obtained green body was placed in a firing furnace having an atmosphere having a H₂ concentration of 0.1 vol % and a N₂ concentration of 99.9%, and the temperature of the firing furnace (the firing temperature) was elevated up to 1, 150° C. at the heating rate of 20,000° C./h, to thereby perform firing for 10 minutes. Thereafter, plating was performed on the base layers of external electrodes, thereby obtaining a multilayer ceramic capacitor (MLCC) with approximate dimensions of 1.0 mm×0.5 mm×0.5 mm. It was assumed from the firing conditions that Cu in the cover layers was present in a metallic state, more specifically, in a state of a simple substance of Cu. The Cu content and Mn content in the cover layer were respectively measured as described above, and the above-described evaluations were also performed.

### Example 1-2

A multilayer ceramic capacitor was produced in the same manner as in Example 1-1, except that an amount of Cu added to the ceramic slurry for forming cover layers was changed so that the number of Cu atoms was 2.0 relative to 100 Ti atoms, and an amount of Mn added was changed so that the number of Mn atoms was 0.5 relative to Ti 100 atoms.

### Example 1-3

A multilayer ceramic capacitor was produced in the same manner as in Example 1-1, except that an amount of Cu added to the ceramic slurry for forming cover layers was changed so that the number of Cu atoms was 2.0 relative to 100 Ti atoms, and an amount of Mn added was changed so that the number of Mn atoms was 1.5 relative to 100 Ti atoms.

### Example 1-4

A multilayer ceramic capacitor was produced in the same manner as in Example 1-1, except that an amount of Cu added to the ceramic slurry for forming cover layers was changed so that the number of Cu atoms was 4.0 relative to 100 Ti atoms, and an amount of Mn added was changed so that the number of Mn atoms was 0.5 relative to 100 Ti atoms.

### Example 1-5

A multilayer ceramic capacitor was produced in the same manner as in Example 1-1, except that an amount of Cu added to the ceramic slurry for forming cover layers was changed so that the number of Cu atoms was 2.0 relative to 100 Ti atoms, and an amount of Mn added was changed so that the number of Mn atoms was 0.2 relative to 100 Ti atoms.

### Example 1-6

A multilayer ceramic capacitor was produced in the same manner as in Example 1-1, except that an amount of Cu added to the ceramic slurry for forming cover layers was changed so that the number of Cu atoms was 1.0 relative to 100 Ti atoms, and an amount of Mn added was changed so that the number of Mn atoms was 0.5 relative to 100 Ti atoms.

### Example 1-7

A multilayer ceramic capacitor was produced in the same manner as in Example 1-1, except that an amount of Cu added to the ceramic slurry for forming cover layers was changed so that the number of Cu atoms was 3.0 relative to 100 Ti atoms, and an amount of Mn added was changed so that the number of Mn atoms was 0.5 relative to 100 Ti atoms.

### Example 1-8

A multilayer ceramic capacitor was produced in the same manner as in Example 1-1, except that an amount of Cu added to the ceramic slurry for forming cover layers was changed so that the number of Cu atoms was 2.0 relative to 100 Ti atoms, and an amount of Mn added was changed so that the number of Mn atoms was 3.0 relative to 100 Ti atoms.

### Comparative Example 1-1

A multilayer ceramic capacitor was produced in the same manner as in Example 1-1, except that an amount of Cu added to the ceramic slurry for forming cover layers was changed so that the number of Cu atoms was 0.3 relative to 100 Ti atoms, and an amount of Mn added was changed so that the number of Mn atoms was 0.5 relative to 100 Ti atoms.

### Comparative Example 1-2

A multilayer ceramic capacitor was produced in the same manner as in Example 1-1, except that an amount of Cu added to the ceramic slurry for forming cover layers was changed so that the number of Cu atoms was 5.0 relative to 100 Ti atoms, and an amount of Mn added was changed so that the number of Mn atoms was 0.5 relative to 100 Ti atoms.

### Comparative Example 1-3

A multilayer ceramic capacitor was produced in the same manner as in Example 1-1, except that an amount of Cu added to the ceramic slurry for forming cover layers was changed so that the number of Cu atoms was 2.0 relative to 100 Ti atoms, an amount of Mn added was changed so that the number of Mn atoms was 0.5 relative to 100 Ti atoms, and the H₂ concentration in the atmosphere during the firing was changed to 0.03 vol %. In Comparative Example 1-3, it was assumed from the firing conditions that Cu was present in the state of an oxide in the cover layer.

### Comparative Example 1-4

A multilayer ceramic capacitor was produced in the same manner as in Example 1-1, except that Cu was not added to the ceramic slurry for forming cover layers, and an amount of Mn added was changed so that the number of Mn atoms was 0.5 relative to 100 Ti atoms.

Production conditions and evaluation results of the above examples and comparative examples are summarized in Table 1.

TABLE 1

| | | Amount | | Amount | | | | | |
|---|---|---|---|---|---|---|---|---|---|
| | Amount of | of Cu | | of Mn | | | | | |
| | Cu added | in cover | | in cover | H₂ | Evaluations | | | |
| | to slurry | layer | State of | layer | concen- | | Current | | |
| | (Cu | (Cu | Cu in | (Mn | tration | | leakage | | Capaci- |
| | atoms/100 | atoms/100 | cover | atoms/100 | during | Moisture | value | Current | tance |
| | Ti atoms) | Ti atoms) | layer *¹ | Ti atoms) | firing | resistance | (μA) | leakage | (μF) |
| Ex. 1-1 | 0.5 | 0.002 | Metal | 0.2 | 0.10% | Good | 150 | Good | 22 |
| Ex. 1-2 | 2.0 | 0.01 | Metal | 0.2 | 0.10% | Good | 210 | Good | 22 |
| Ex. 1-3 | 2.0 | 0.01 | Metal | 1.0 | 0.10% | Good | 210 | Good | 21 |
| Ex. 1-4 | 4.0 | 0.09 | Metal | 0.2 | 0.10% | Good | 800 | Good | 21 |
| Ex. 1-5 | 2.0 | 0.01 | Metal | 0.05 | 0.10% | Good | 210 | Good | 22 |
| Ex. 1-6 | 1.0 | 0.004 | Metal | 0.2 | 0.10% | Good | 180 | Good | 22 |
| Ex. 1-7 | 3.0 | 0.06 | Metal | 0.2 | 0.10% | Good | 500 | Good | 21 |
| Ex. 1-8 | 2.0 | 0.01 | Metal | 1.5 | 0.10% | Good | 210 | Good | 17 |
| Comp. Ex. 1-1 | 0.3 | 0.001 | Metal | 0.2 | 0.10% | Poor | 120 | Good | 22 |
| Comp. Ex. 1-2 | 5.0 | 0.2 | Metal | 0.2 | 0.10% | Good | 2000 | Poor | 17 |
| Comp. Ex. 1-3 | 2.0 | 0.01 | Oxide | 0.2 | 0.03% | Poor | 100 | Good | 22 |
| Comp. Ex. 1-4 | 0 | — | — | 0.2 | 0.10% | Poor | 100 | Good | 22 |

*¹ Estimation from the firing conditions

The current leakage of the multilayer ceramic capacitor may be preferably 1,500 μA or less, more preferably 1,000 μA or less, yet more preferably 800 μA or less, and yet further more preferably 500 μA or less.

Moreover, the capacitance of the multilayer ceramic capacitor is preferably 15 μF or greater, more preferably 17 μF or greater, yet more preferably 20 μF or greater, and yet further more preferably 21 μF or greater.

It was found from Table 1 that a multilayer ceramic capacitor that had excellent moisture resistance and inhibited current leakage could be obtained with relatively low firing temperatures in Examples 1-1 to 1-8 in which the amount of Cu in the cover layer was such that the number of Cu atoms relative to 100 Ti atoms was in the range of 0.002 or greater and 0.15 or less and Cu was present in a metallic state. Moreover, it was found that the multilayer ceramic capacitors of Examples 1-1 to 1-7, in which the amount of Mn in the cover layer was such that the number of Mn atoms relative to 100 Ti atoms was 1.2 or less, sufficiently maintained the capacitance (the capacitance was in the range of 20 μF or greater). However, the capacitance was relatively low in Examples 1-3, 1-4, and 1-7. It was assumed that the relatively large Mn content in the cover layer affected the capacitance in Example 1-3, and a slight increase in current leakage due to the relatively large Cu content in the cover layer affected the capacitance in Examples 1-4 and Example 1-7. Conversely, a multilayer ceramic capacitor achieving both excellent moisture resistance and a current leakage inhibition effect was not obtained in Comparative Examples 1-1 to 1-4.

### 2. Example where Cu is Added to Paste for Forming Internal Electrode Layers Corresponding to all Internal Electrode Layers

### Example 2-1

Ceramic slurry for forming cover layers, which included barium titanate as a main component, was prepared. To the ceramic slurry for forming cover layers, Mn was added so that the number of Mn atoms relative to 100 Ti atoms was 0.5. Note that Mn was added in the form of a carbonate (MnCO₃). Cover sheets that would become cover layers were produced using the ceramic slurry. Moreover, as preparation of a metal paste for forming internal electrodes, a Cu-containing Ni paste was prepared by adding Cu so that the number of Cu atoms relative to 100 Ni atoms was 1.0.

The Cu-containing Ni paste was printed on a dielectric green sheet that would become a dielectric layer including barium titanate as a main component. A stack was prepared by stacking 500 sheets of the above dielectric green sheets on which the Cu-containing Ni paste had been printed, and the cover sheets were respectively disposed on the outer sides of the stack. The resultant stack was cut into a predetermined size to obtain a green body. The obtained green body was subjected to degreasing in a N₂ atmosphere, and then a nickel paste that would become base layers of external electrodes was applied by dip coating, thereby obtaining a green body (unfired green body).

The obtained green body was placed in a firing furnace having an atmosphere having a H₂ concentration of 0.03 vol % and a N₂ concentration of 99.97%, and the temperature of the firing furnace (the firing temperature) was elevated up to 900° C., to thereby perform firing (weak reduction firing) for 10 minutes. Thereafter, the atmosphere was switched to an atmosphere having a H₂ concentration of 0.1 vol % and a N₂ concentration of 99.9%, and the temperature of the firing furnace (the firing temperature) was elevated up to 1,150° C. at the heating rate of 20,000° C./h, to thereby perform firing (strong reduction firing) for 10 minutes. Subsequently, plating was performed on the base layers of external electrodes, thereby obtaining a multilayer ceramic capacitor (MLCC) with approximate dimensions of 1.0 mm×0.5 mm×0.5 mm. It was assumed from the firing conditions that Cu was present in a metallic state in the cover layers, more specifically, in a state of a simple substance of Cu. The Cu content and Mn content in the cover layer were respectively measured as described above, and the above-described evaluations were also performed.

### Example 2-2

A multilayer ceramic capacitor was produced in the same manner as in Example 2-1, except that an amount of Cu added to the Ni paste that would become internal electrode layers was changed so that the number of Cu atoms was 3.0 relative to 100 Ni atoms, and the amount of Mn added to the ceramic slurry for forming cover layers was changed so that the number of Mn was 0.5 relative to 100 Ti atoms.

### Example 2-3

A multilayer ceramic capacitor was produced in the same manner as in Example 2-1, except that an amount of Cu added to the Ni paste that would become internal electrode layers was changed so that the number of Cu atoms was 3.0 relative to 100 Ni atoms, and the amount of Mn added to the ceramic slurry for forming cover layers was changed so that the number of Mn was 1.5 relative to 100 Ti atoms.

### Example 2-4

A multilayer ceramic capacitor was produced in the same manner as in Example 2-1, except that an amount of Cu added to the Ni paste that would become internal electrode layers was changed so that the number of Cu atoms was 5.0 relative to 100 Ni atoms, and the amount of Mn added to the ceramic slurry for forming cover layers was changed so that the number of Mn was 0.5 relative to 100 Ti atoms.

### Example 2-5

A multilayer ceramic capacitor was produced in the same manner as in Example 2-1, except that an amount of Cu added to the Ni paste that would become internal electrode layers was changed so that the number of Cu atoms was 3.0 relative to 100 Ni atoms, and the amount of Mn added to the ceramic slurry for forming cover layers was changed so that the number of Mn was 0.2 relative to 100 Ti atoms.

### Example 2-6

A multilayer ceramic capacitor was produced in the same manner as in Example 2-1, except that an amount of Cu added to the Ni paste that would become internal electrode layers was changed so that the number of Cu atoms was 1.5 relative to 100 Ni atoms, and the amount of Mn added to the ceramic slurry for forming cover layers was changed so that the number of Mn was 0.5 relative to 100 Ti atoms.

### Example 2-7

A multilayer ceramic capacitor was produced in the same manner as in Example 2-1, except that an amount of Cu added to the Ni paste that would become internal electrode layers was changed so that the number of Cu atoms was 4.0 relative to 100 Ni atoms, and the amount of Mn added to the ceramic slurry for forming cover layers was changed so that the number of Mn was 0.5 relative to 100 Ti atoms.

### Example 2-8

A multilayer ceramic capacitor was produced in the same manner as in Example 2-1, except that an amount of Cu added to the Ni paste that would become internal electrode layers was changed so that the number of Cu atoms was 3.0 relative to 100 Ni atoms, and the amount of Mn added to the ceramic slurry for forming cover layers was changed so that the number of Mn was 3.0 relative to 100 Ti atoms.

### Comparative Example 2-1

A multilayer ceramic capacitor was produced in the same manner as in Example 2-1, except that an amount of Cu added to the Ni paste that would become internal electrode layers was changed so that the number of Cu atoms was 0.2 relative to 100 Ni atoms, and the amount of Mn added to the ceramic slurry for forming cover layers was changed so that the number of Mn was 0.5 relative to 100 Ti atoms.

### Comparative Example 2-2

A multilayer ceramic capacitor was produced in the same manner as in Example 2-1, except that an amount of Cu added to the Ni paste that would become internal electrode layers was changed so that the number of Cu atoms was 10 relative to 100 Ni atoms, and the amount of Mn added to the ceramic slurry for forming cover layers was changed so that the number of Mn was 0.5 relative to 100 Ti atoms.

### Comparative Example 2-3

A multilayer ceramic capacitor was produced in the same manner as in Example 2-1, except that an amount of Cu added to the Ni paste that would become internal electrode layers was changed so that the number of Cu atoms was 3.0 relative to 100 Ni atoms, the amount of Mn added to the ceramic slurry for forming cover layers was changed so that the number of Mn was 3.0 relative to 100 Ti atoms, and the H₂ concentration of the atmosphere during the weak reduction firing was changed to 0.10 vol %. Note that it was assumed from the firing conditions that in this example, Cu was present in the form of an oxide in the cover layers.

### Comparative Example 2-4

A multilayer ceramic capacitor was produced in the same manner as in Example 2-1, except that an amount of Cu added to the Ni paste that would become internal electrode layers was changed so that the number of Cu atoms was 3.0 relative to 100 Ni atoms, the amount of Mn added to the ceramic slurry for forming cover layers was changed so that the number of Mn was 0.5 relative to 100 Ti atoms, and the H₂ concentration of the atmosphere during the strong reduction firing was changed to 0.03 volt. Note that it was assumed from the firing conditions that in this example, Cu was present in the form of an oxide in the cover layers.

### Comparative Example 2-5

A multilayer ceramic capacitor was produced in the same manner as in Example 2-1, except that Cu was not added to the Ni paste that would become internal electrode layers, and the amount of Mn added to the ceramic slurry for forming cover layers was changed so that the number of Mn was 0.5 relative to 100 Ti atoms.

Production conditions and evaluation results of the above examples and comparative examples are summarized in Table 2.

TABLE 2

| | | | | | H₂ concentration | | | | | |
|---|---|---|---|---|---|---|---|---|---|---|
| | Amount of Cu | | | | during firing | | Evaluations | | | |
| | added to Ni | Amount of Cu | | Amount of Mn | During | During | | Current | | |
| | paste | in cover layer | | in cover layer | weak | strong | | leakage | | Capaci- |
| | (Cu atoms/100 | (Cu atoms/100 | State of Cu in | (Mn atoms/100 | reduction | reduction | Moisture | value | Current | tance |
| | Ni atoms) | Ti atoms) | cover layer *² | Ti atoms) | firing | firing | resistance | (μA) | leakage | (μF) |
| Ex. 2-1 | 1.0 | 0.002 | Metal | 0.2 | 0.03% | 0.10% | Good | 150 | Good | 22 |
| Ex. 2-2 | 3.0 | 0.01 | Metal | 0.2 | 0.03% | 0.10% | Good | 210 | Good | 22 |
| Ex. 2-3 | 3.0 | 0.01 | Metal | 1.0 | 0.03% | 0.10% | Good | 210 | Good | 21 |
| Ex. 2-4 | 5.0 | 0.09 | Metal | 0.2 | 0.03% | 0.10% | Good | 800 | Good | 21 |
| Ex. 2-5 | 3.0 | 0.01 | Metal | 0.05 | 0.03% | 0.10% | Good | 210 | Good | 22 |
| Ex. 2-6 | 1.5 | 0.004 | Metal | 0.2 | 0.03% | 0.10% | Good | 180 | Good | 22 |
| Ex. 2-7 | 4.0 | 0.06 | Metal | 0.2 | 0.03% | 0.10% | Good | 500 | Good | 21 |
| Ex. 2-8 | 3.0 | 0.01 | Metal | 1.5 | 0.03% | 0.10% | Good | 210 | Good | 17 |
| Comp. Ex. 2-1 | 0.2 | 0.001 | Metal | 0.2 | 0.03% | 0.10% | Poor | 120 | Good | 22 |
| Comp. Ex. 2-2 | 10 | 0.2 | Metal | 0.2 | 0.03% | 0.10% | Good | 2000 | Poor | 17 |
| Comp. Ex. 2-3 | 3.0 | 0.001 | Metal | 0.2 | 0.10% | 0.10% | Poor | 120 | Good | 22 |
| Comp. Ex. 2-4 | 3.0 | 0.01 | Oxide | 0.2 | 0.03% | 0.03% | Poor | 100 | Good | 22 |
| Comp. Ex. 2-5 | — | — | — | 0.2 | 0.03% | 0.10% | Poor | 100 | Good | 22 |

*² Estimation from the firing conditions

It was found from Table 2 that a multilayer ceramic capacitor that had excellent moisture resistance and inhibited current leakage could be obtained in Examples 2-1 to 2-8 in which the amount of Cu in the cover layer was such that the amount of Cu atoms relative to 100 Ti atoms was in the range of 0.002 or greater and 0.15 or less and Cu was present in a metallic state. Moreover, it was found that the multilayer ceramic capacitors of Examples 2-1 to 2-7, in which the amount of Mn in the cover layer was such that the number of Mn atoms relative to 100 Ti atoms was 1.2 or less, sufficiently maintained the capacitance. However, the capacitance was relatively low in Examples 2-3, 2-4, and 2-7. It was assumed that the relatively large Mn content in the cover layer affected the capacitance in Example 2-3, and a slight increase in current leakage due to the relatively large Cu content in the cover layer affected the capacitance in Examples 2-4 and Example 2-7. Conversely, a multilayer ceramic capacitor achieving both excellent moisture resistance and a current leakage inhibition effect was not obtained in Comparative Examples 2-1 to 2-6.

### =Cu Concentration of Outermost Internal Electrode Layer and Central Internal Electrode Layer Among Internal Electrode Layers=

Table 3 presents the Cu content in the outermost internal electrode layer in the stacking direction and the Cu content in the internal electrode layer located in the central part in the stacking direction for some of the samples presented in Tables 1 and 2. In Example 1-4 in which Cu was added to the ceramic slurry for forming cover layers, the Cu content in the outermost internal electrode layer in the stacking direction was two times or greater the Cu content in the internal electrode layer located in the central part in the stacking direction. Moreover, in Example 1-1, diffusion of Cu from the cover layer to the outermost internal electrode layer was observed, but the Cu content in the internal electrode layer located in the central part was equal to or lower than the detection limit, and it was therefore found that the internal electrode layer located in the central part was substantially free of Cu. Conversely, in Example 2-4 in which Cu was added to the paste material of internal electrode layers, the Cu content in the internal electrode layer located in the central part in the stacking direction was 1.1 times the Cu content in the outermost internal electrode layer in the stacking direction. The Cu content in the internal electrode layer located in the central part in the stacking direction was 4 times the Cu content in the outermost internal electrode layer in the stacking direction in Example 2-1. This was probably because, even if the amount of Cu was equal in each of the internal electrode layers before diffusion, the diffusion to the cover layer occurred during firing so that the amount of Cu diffused into the cover layer increased and the amount of Cu remaining significantly decreased in the internal electrode layer in the vicinity of the cover layer, whereas there was almost no diffusion of Cu to the cover layer occurred in the internal electrode layer that was not in the vicinity of the cover layer and was located in the central part, and therefore most of the amount of Cu close to the initial value remained.

TABLE 3

| | Amount of Cu | Amount of Cu | | Amount of Cu | Amount of Cu in |
|---|---|---|---|---|---|
| | added to | added to Ni | Amount of Cu | in outermost | internal electrode |
| | slurry | paste | in cover layer | electrode | of central part |
| | (Cu atoms/100 | (Cu atoms/100 | (Cu atoms/100 | (Cu atoms/100 | (Cu atoms/100 |
| | Ti atoms) | Ni atoms) | Ti atoms) | Ni atoms) | Ni atoms) |
| Ex. 1-1 | 0.5 | — | 0.002 | 2.5 | Detection limit or less |
| Ex. 1-4 | 4.0 | — | 0.09 | 5.3 | 2.1 |
| Ex. 2-1 | — | 1.0 | 0.002 | 0.2 | 0.8 |
| Ex. 2-4 | — | 5.0 | 0.09 | 4.4 | 4.9 |

### 3. Example where Cu is Added Only to Paste for Forming Internal Electrode Layers that Will Become Uppermost Layer and Lowermost Layer

### Example 3-1

Ceramic slurry for forming cover layers, which included barium titanate as a main component, was prepared. To the ceramic slurry for forming cover layers, Mn was added so that the number of Mn atoms relative to 100 Ti atoms was 0.5. Note that Mn was added in the form of a carbonate (MnCO₃). Cover sheets that would become cover layers were produced using the ceramic slurry. Moreover, as preparation of a metal paste for forming internal electrode layers, a Cu-containing Ni paste was prepared by adding Cu so that the number of Cu atoms relative to 100 Ni atoms was 1.0, and a Cu-free Ni paste was prepared without adding Cu.

The above-mentioned Cu-containing Ni paste and Cu-free Ni paste were printed on corresponding dielectric green sheets that would become dielectric layers including barium titanate as a main component. A stack was obtained by stacking 498 sheets of the dielectric green sheets on each of which the Cu-free Ni paste was printed, and stacking as uppermost and lowermost layers, the dielectric green sheets on each of which the Cu-containing Ni paste was printed, respectively. The cover sheets were respectively disposed on the outer sides of the stack. The resultant stack was cut into a predetermined size to obtain a green body. The obtained green body was subjected to degreasing in a N₂ atmosphere, and then a nickel paste that would become base layers of external electrodes was applied by dip coating, thereby obtaining a green body (unfired green body).

The obtained green body was placed in a firing furnace having an atmosphere having a H₂ concentration of 0.03 vol % and a N₂ concentration of 99.97%, and the temperature of the firing furnace (the firing temperature) was elevated up to 900° C., to thereby perform firing (weak reduction firing) for 10 minutes. Thereafter, the atmosphere was switched to an atmosphere having a H₂ concentration of 0.1 vol % and a N₂ concentration of 99.98, and the temperature of the firing furnace (the firing temperature) was elevated up to 1,150° C. at the heating rate of 20,000° C./h, to thereby perform firing (strong reduction firing) for 10 minutes. Subsequently, plating was performed on the base layers of external electrodes, thereby obtaining a multilayer ceramic capacitor (MLCC) with approximate dimensions of 1.0 mm×0.5 mm×0.5 mm. It was assumed from the firing conditions that Cu was present in a metallic state in the cover layers, more specifically, in a state of a simple substance of Cu. The Cu content and Mn content in the cover layer were respectively measured as described above, and the above-described evaluations were also performed.

### Example 3-2

A multilayer ceramic capacitor was produced in the same manner as in Example 3-1, except that, in the preparation of the Cu-containing Ni paste, an amount of Cu added was changed so that the number of Cu atoms was 3.0 relative to 100 Ni atoms.

### Example 3-3

A multilayer ceramic capacitor was produced in the same manner as in Example 3-1, except that, in the preparation of the Cu-containing Ni paste, an amount of Cu added was changed so that the number of Cu atoms was 5.0 relative to 100 Ni atoms.

### Comparative Example 3-1

A multilayer ceramic capacitor was produced in the same manner as in Example 3-1, except that, in the preparation of the Cu-containing Ni paste, an amount of Cu added was changed so that the number of Cu atoms was 0.2 relative to 100 Ni atoms.

### Comparative Example 3-2

A multilayer ceramic capacitor was produced in the same manner as in Example 3-1, except that, in the preparation of the Cu-containing Ni paste, an amount of Cu added was changed so that the number of Cu atoms was 10 relative to 100 Ni atoms.

### Comparative Example 3-3

A multilayer ceramic capacitor was produced in the same manner as in Example 3-1, except that Cu was not added to the Ni paste, specifically, only the Cu-free Ni paste was used as the paste for forming internal electrode layers.

Production conditions and evaluation results of the above examples and comparative examples are summarized in Table 4.

TABLE 4

| | | | | | H₂ concentration | | | | | |
|---|---|---|---|---|---|---|---|---|---|---|
| | Amount of Cu | | | | during firing | | Evaluations | | | |
| | added to Ni | Amount of Cu | | Amount of Mn | During | During | | Current | | |
| | paste | in cover layer | | in cover layer | weak | strong | | leakage | | Capaci- |
| | (Cu atoms/100 | (Cu atoms/100 | State of Cu in | (Mn atoms/100 | reduction | reduction | Moisture | value | Current | tance |
| | Ni atoms) | Ti atoms) | cover layer *³ | Ti atoms) | firing | firing | resistance | (μA) | leakage | (μF) |
| Ex. 3-1 | 1.0 | 0.002 | Metal | 0.2 | 0.03% | 0.10% | Good | 150 | Good | 22 |
| Ex. 3-2 | 3.0 | 0.01 | Metal | 0.2 | 0.03% | 0.10% | Good | 210 | Good | 22 |
| Ex. 3-3 | 5.0 | 0.09 | Metal | 0.2 | 0.03% | 0.10% | Good | 800 | Good | 21 |
| Comp. Ex. 3-1 | 0.2 | 0.001 | Metal | 0.2 | 0.03% | 0.10% | Poor | 120 | Good | 22 |
| Comp. Ex. 3-2 | 10 | 0.2 | Metal | 0.2 | 0.03% | 0.10% | Good | 2000 | Poor | 17 |
| Comp. Ex. 3-3 | — | — | — | 0.2 | 0.03% | 0.10% | Poor | 100 | Good | 22 |

*³ Estimation from the firing conditions

It was found from Table 4 that, even in the case of the example where Cu was added only to the paste for forming internal electrode layers, that would become an uppermost internal electrode layer and a lowermost internal electrode layer, a multilayer ceramic capacitor that inhibited current leakage could be obtained as in Examples 3-1 to 3-3 in which the amount of Cu in the cover layer was such that the amount of Cu atoms relative to 100 Ti atoms was in the range of 0.002 or greater and 0.15 or less and Cu was present in a metallic state.

As described above, according to one aspect of the present disclosure, a multilayer ceramic capacitor, which can be produced at relatively low firing temperatures and has excellent moisture resistance, can be provided.

Although the embodiments have been described in detail, the present disclosure is not limited to the above-described embodiments. Moreover, various changes, modifications, substitutions, addition, deletion, combination, and the like can be made on the above-described embodiments within the scope described in the claims.

Embodiments of the present disclosure are, for example, as follows.

<1>A multilayer ceramic capacitor includes a capacitance portion and a cover layer. In the capacitance portion, dielectric layers and internal electrode layers are alternately stacked. The cover layer is arranged on an outer side of the capacitance portion in a stacking direction of the capacitance portion. The cover layer includes a perovskite compound represented by a general formula ABO₃, and includes one or more elements selected from the group consisting of Cu, Au, Ag, Al, Ir, and W in a metallic state. A number of atoms of the one or more elements is 0.002 or greater and 0.15 or less relative to 100 atoms of a B-site element of the general formula.

<2> In the multilayer ceramic capacitor of <1>, among the internal electrode layers, a concentration of one or more elements selected from the group consisting of Cu, Au, Ag, Al, Ir, and W in an internal electrode layer in a vicinity of the cover layer is higher than a concentration of the one or more elements in an internal electrode layer located in a central part of the capacitance portion in the stacking direction.

<3> In the multilayer ceramic capacitor of <2>, the concentration of the one or more elements selected from the group consisting of Cu, Au, Ag, Al, Ir, and W in the internal electrode layer located in the central part of the capacitance portion in the stacking direction is 1.2 times or greater the concentration of the one or more elements in the internal electrode layer in the vicinity of the cover layer.

<4> In the multilayer ceramic capacitor of <2>, the internal electrode layer located in the central part of the capacitance portion in the stacking direction is substantially free of the one or more elements selected from the group consisting of Cu, Au, Ag, Al, Ir, and W.

<5> In the multilayer ceramic capacitor of <1>, among the internal electrode layers, a concentration of one or more elements selected from the group consisting of Cu, Au, Ag, Al, Ir, and W in an internal electrode layer in a vicinity of the cover layer is lower than a concentration of the one or more elements in an internal electrode layer located in a central part of the capacitance portion in the stacking direction.

<6> In the multilayer ceramic capacitor of <5>, the concentration of the one or more elements selected from the group consisting of Cu, Au, Ag, Al, Ir, and W in the internal electrode layer located in the central part of the capacitance portion in the stacking direction is 1.1 times or greater the concentration of the one or more elements in the internal electrode layer in the vicinity of the cover layer.

<7> In the multilayer ceramic capacitor of <6>, the concentration of the one or more elements selected from the group consisting of Cu, Au, Ag, Al, Ir, and W in the internal electrode layer located in the central part of the capacitance portion in the stacking direction is 4 times or greater the concentration of the one or more elements in the internal electrode layer in the vicinity of the cover layer.

<8> In the multilayer ceramic capacitor of <1> or <2>, a number of Mn atoms relative to 100 atoms of the B-site element is 1.2 or less in the cover layer.

<9> In the multilayer ceramic capacitor of <1>, <2>, or <5>, the cover layer includes a Cu metal.

<10> In the multilayer ceramic capacitor of <1>, <2>, or <5>, the perovskite compound in the cover layer includes barium titanate.

<11>A method of producing a multilayer ceramic capacitor includes: alternately stacking an unfired dielectric material for forming dielectric layers and an unfired internal electrode material for forming internal electrode layers, and arranging an unfired cover material for forming a cover layer, thereby forming a stack; and firing the stack, thereby forming a multilayer ceramic capacitor including a capacitor portion, in which the dielectric layers and the internal electrode layers are alternately stacked, and the cover layer arranged on an outer side of the capacitance portion in a direction of the stacking, where the cover layer includes a perovskite compound represented by a general formula ABO₃. After the firing, the cover layer includes one or more elements selected from the group consisting of Cu, Au, Ag, Al, Ir, and W in a metallic state, and a number of the one or more elements is 0.002 or greater and 0.15 or less relative to 100 atoms of a B-site element of the general formula.

<12> In the method of <11>, the unfired cover material is formed by adding one or more elements selected from the group consisting of Cu, Au, Ag, Al, Ir, and W.

<13> In the method of <11>, as the unfired internal electrode material, a first internal electrode material and a second electrode material are prepared, where the first internal electrode material is formed by adding one or more elements selected from the group consisting of Cu, Au, Ag, Al, Ir, and W, and the second internal electrode material is formed in a manner such that the second internal electrode material is free of the one or more elements selected from the group consisting of Cu, Au, Ag, Al, Ir, and W. The first internal electrode material is used to form an uppermost internal electrode layer, a lowermost internal electrode layer, or both in the direction of the stacking, and the second electrode material is used to form an internal electrode layer located in a central part of the capacitance portion in the direction of the stacking.

<14> In the method of <11>, as the unfired internal electrode material, a first internal electrode material formed by adding one or more elements selected from the group consisting of Cu, Au, Ag, Al, Ir, and W is prepared, and the first internal electrode material is used to form all of the internal electrode layers.

<15> In the method according to any one of <11> to <14>, the firing is performed at 1, 200° C. or lower.

<16> In the method of <12>, the firing includes main firing, the main firing being performed at 900° C. or higher and 1,270° C. or lower in an atmosphere having a H₂ concentration of 0.08 vol % or greater and 1.0 vol % or less.

<17> In the method of <13> or <14>, the firing includes pre-firing performed at 950° C. or lower in an atmosphere having a H₂ concentration of 0.01 vol % or greater and 0.08 vol % or less, and main firing performed at 900° C. or higher and 1,270° C. or lower in an atmosphere having a H₂ concentration of 0.08 vol % or greater and 1.0 vol % or less.

What is claimed is:

1. A multilayer ceramic capacitor, comprising:
a capacitance portion in which dielectric layers and internal electrode layers are alternately stacked; and
a cover layer arranged on an outer side of the capacitance portion in a stacking direction of the capacitance portion, the cover layer including a perovskite compound represented by a general formula ABO₃, and including one or more elements selected from the group consisting of Cu, Au, Ag, Al, Ir, and W in a metallic state, where a number of atoms of the one or more elements is 0.002 or greater and 0.15 or less relative to 100 atoms of a B-site element of the general formula.

2. The multilayer ceramic capacitor according to claim 1,
wherein among the internal electrode layers, a concentration of one or more elements selected from the group consisting of Cu, Au, Ag, Al, Ir, and W in an internal electrode layer in a vicinity of the cover layer is higher than a concentration of the one or more elements in an internal electrode layer located in a central part of the capacitance portion in the stacking direction.

3. The multilayer ceramic capacitor according to claim 2,
wherein the concentration of the one or more elements selected from the group consisting of Cu, Au, Ag, Al, Ir, and W in the internal electrode layer located in the central part of the capacitance portion in the stacking direction is 1.2 times or greater the concentration of the one or more elements in the internal electrode layer in the vicinity of the cover layer.

4. The multilayer ceramic capacitor according to claim 2,
wherein the internal electrode layer located in the central part of the capacitance portion in the stacking direction is substantially free of the one or more elements selected from the group consisting of Cu, Au, Ag, Al, Ir, and W.

5. The multilayer ceramic capacitor according to claim 1,
wherein among the internal electrode layers, a concentration of one or more elements selected from the group consisting of Cu, Au, Ag, Al, Ir, and W in an internal electrode layer in a vicinity of the cover layer is lower than a concentration of the one or more elements in an internal electrode layer located in a central part of the capacitance portion in the stacking direction.

6. The multilayer ceramic capacitor according to claim 5,
wherein the concentration of the one or more elements selected from the group consisting of Cu, Au, Ag, Al, Ir, and W in the internal electrode layer located in the central part of the capacitance portion in the stacking direction is 1.1 times or greater the concentration of the one or more elements in the internal electrode layer in the vicinity of the cover layer.

7. The multilayer ceramic capacitor according to claim 6,
wherein the concentration of the one or more elements selected from the group consisting of Cu, Au, Ag, Al, Ir, and W in the internal electrode layer located in the central part of the capacitance portion in the stacking direction is 4 times or greater the concentration of the one or more elements in the internal electrode layer in the vicinity of the cover layer.

8. The multilayer ceramic capacitor according to claim 1,
wherein a number of Mn atoms relative to 100 atoms of the B-site element is 1.2 or less in the cover layer.

9. The multilayer ceramic capacitor according to claim 1,
wherein the cover layer includes a Cu metal.

10. The multilayer ceramic capacitor according to claim 1,
wherein the perovskite compound in the cover layer includes barium titanate.

11. A method of producing a multilayer ceramic capacitor, the method comprising:
alternately stacking an unfired dielectric material for forming dielectric layers and an unfired internal electrode material for forming internal electrode layers, and arranging an unfired cover material for forming a cover layer, thereby forming a stack; and
firing the stack, thereby forming a multilayer ceramic capacitor including a capacitor portion, in which the dielectric layers and the internal electrode layers are alternately stacked, and the cover layer arranged on an outer side of the capacitance portion in a direction of the stacking, where the cover layer includes a perovskite compound represented by a general formula ABO₃,
wherein after the firing, the cover layer includes one or more elements selected from the group consisting of Cu, Au, Ag, Al, Ir, and W in a metallic state, and a number of the one or more elements is 0.002 or greater and 0.15 or less relative to 100 atoms of a B-site element of the general formula.

12. The method according to claim 11,
wherein the unfired cover material is formed by adding one or more elements selected from the group consisting of Cu, Au, Ag, Al, Ir, and W.

13. The method according to claim 11,
wherein as the unfired internal electrode material, a first internal electrode material and a second electrode material are prepared, where the first internal electrode material is formed by adding one or more elements selected from the group consisting of Cu, Au, Ag, Al, Ir, and W, and the second internal electrode material is formed in a manner such that the second internal electrode material is free of the one or more elements selected from the group consisting of Cu, Au, Ag, Al, Ir, and W, and
wherein the first internal electrode material is used to form an uppermost internal electrode layer, a lowermost internal electrode layer, or both in the direction of the stacking, and the second electrode material is used to form an internal electrode layer located in a central part of the capacitance portion in the direction of the stacking.

14. The method according to claim 11,
wherein as the unfired internal electrode material, a first internal electrode material formed by adding one or more elements selected from the group consisting of Cu, Au, Ag, Al, Ir, and W is prepared, and the first internal electrode material is used to form all of the internal electrode layers.

15. The method according to claim 11,
wherein the firing is performed at 1,270° C. or lower.

16. The method according to claim 12,
wherein the firing includes main firing, the main firing being performed at 900° C. or higher and 1,270° C. or lower in an atmosphere having a H₂ concentration of 0.08 vol % or greater and 1.0 vol % or less.

17. The method according to claim 14,
wherein the firing includes
pre-firing performed at 950° C. or lower in an atmosphere having a H₂ concentration of 0.01 vol % or greater and 0.08 vol % or less, and
main firing performed at 900° C. or higher and 1,270° C. or lower in an atmosphere having a H₂ concentration of 0.08 vol % or greater and 1.0 vol % or less.
